(19) United States
(12) Patent Application Publication
(10) Pub. No.: US 2015/0133167 A1
(43) Pub. Date: May 14, 2015

(54) TECHNIQUES FOR EFFICIENT RF HEAT MAP REPRESENTATION

(71) Applicant: QUALCOMM Incorporated, San Diego, CA (US)

(72) Inventor: Stephen William EDGE, Escondido, CA (US)

(21) Appl. No.: 14/530,489

(22) Filed: Oct. 31, 2014

Related U.S. Application Data
(60) Provisional application No. 61/901,943, filed on Nov. 8, 2013.
(60) Provisional application No. 61/921,272, filed on Dec. 27, 2013.

(51) Int. Cl. H04W 4/02; H04W 64/00; G06T 11/20

(52) U.S. Cl. CPC H04W 4/025; G06T 11/206; H04W 64/00
USPC 455/456.3

(57) ABSTRACT

Techniques are described for aligning heat map information more efficiently to an actual geometry of an area of interest. A sequence is generated corresponding to consecutive runs of included and/or excluded grid points. The sequence is provided to a device in addition to heat map information corresponding to a number of grid points. The provided heat map information may be compressed and/or may be assigned to grid points in a reoriented area overlaying the area of interest. The device uses the sequence to map the heat map information to grid points in an area. In one technique, information corresponding to inaccessible locations are excluded from the heat map.

### CROSS-REFERENCE TO RELATED APPLICATIONS

The present application claims the benefit of and priority to Provisional Application No. 61/901,943 entitled “Extension of WiFi Heat Map” filed Nov. 8, 2013, and Provisional Application No. 61/921,272 entitled “Systems and Methods to Enable Efficient RF Heat Maps” filed Dec. 27, 2013, which are assigned to the assignee hereof and expressly incorporated by reference herein.

### TECHNICAL FIELD

The present disclosure relates generally to representing data on a grid of points, and in particular, to efficiently representing and providing RF heat map data to a device.

### BACKGROUND

Generally, a location of a mobile device (e.g., a location fix or location estimate) may be determined using measurements made by the mobile device of radio signals transmitted by one or more transmitters. These transmitters may include access points, base stations and/or navigation satellites which may be situated at known or, in some cases, unknown locations. Obtaining a location fix for a mobile device has become a critically important function in recent years. For mobile devices, there are numerous applications and web-based services that take advantage of the location fix of the device. For example, a map application on a mobile device or on a remote web server can select appropriate maps, directions, driving routes, etc., based on the current location of the mobile device and, in some cases, the velocity of the mobile device. A social networking application can identify other users within the vicinity based on the location of the mobile device. Many other examples exist.

Different techniques for obtaining a position fix for a mobile device may be appropriate under different conditions. In an outdoor environment, satellite-based approaches, e.g., GNSS (Global Navigation Satellite System) techniques may be suitable, because the mobile device may be able to receive satellite-based positioning signals with specific and measurable timing characteristics that depend on the location of the mobile device. Based on reception and measurement of such satellites signals, a position fix for the mobile device may be calculated either by the mobile device or by a separate server (e.g., a location server) to which the measurements are sent. However, satellite-based approaches are not preferred in indoor environments, because satellite signals cannot always be received or accurately measured indoors.

In indoor environments, such as a shopping mall, airport, sports arena, convention center, office building, etc., terrestrial-based approaches making use of signals transmitted from cellular base stations (BSs) and/or wireless local area network (WLAN) access points (APs) are generally more useful for obtaining an accurate location fix for a mobile device. The mobile device observes and measures signals sent from BSs and/or APs which may be at known locations. Different types of signal measurements may be obtained such as RSSI (Received Signal Strength Indication), RTT (Round-trip signal propagation Time), Observed Time Difference Of Arrival (OTDOA) and the like. Such measurements may allow the mobile device or a separate location server to estimate the distance of the mobile device to each BS and/or AP and/or to estimate characteristics of the distance such as the difference in the distance of the mobile device to each of two APs or two BSs. Trilateration may then be performed to estimate the location of the mobile device, based on the distances (or differences in the distances) to different BSs and/or APs and the known locations of the BSs and/or APs.

In another example, the mobile device may compare the measured RSSI and/or measured RTT for each BS or AP to a grid of data providing the expected RSSI and/or expected RTT for a particular BS or AP at different locations of the mobile device. The mobile device may then determine its location using a number of such data grids for each of a plurality of APs and/or BSs, using a process such as pattern matching, by finding a particular location for which the expected RSSIs and/or expected RTTs according to the data grids for some among the plurality of BSs and/or APs most closely match the RSSIs and/or RTTs measured by the mobile device. In this case, the device does not need to know locations of the BSs and APs.

Indoor heat maps for Wi-Fi APs and Bluetooth® APs containing RSSI and/or RTT values are conventionally defined for rectangular areas aligned with a local X,Y coordinate system. Such rectangular areas may align moderately well with the coverage area of an AP, but may not always fit the geometry and dimensions of indoor areas. For example, there may be building corridors (e.g., at an airport) that are at an angle to the X and Y axes or there may be open areas above ground level (e.g., an atrium) that are not accessible to a user and for which RSSI and RTT values in a heat map are of no use to locate the user. Although a rectangular heat map area can still be overlaid on the accessible part of an indoor area in these cases, a significant fraction of the heat map area may end up covering inaccessible locations. As a result, unnecessary extra data corresponding to the inaccessible grid points may be sent to a device and stored in its memory. Therefore, there is a need in the art for systems and methods that align a heat map with actual geometry of an area of interest for efficient use of the resources.

### SUMMARY

A method for providing access point (AP) vicinity information is disclosed. The method includes, in part, defining a rectangular array of grid points, and determining a plurality of grid points based on the rectangular array of grid points. The plurality of grid points overlay an area of interest and form a predefined shape. In one example, the predefined shape corresponds to the rectangular array and the plurality of grid points corresponds to the rectangular array of grid points. In another example, the predefined shape resembles a parallelogram and the plurality of grid points is a transformation of the rectangular array of grid points based on an angle.

The method further includes, in part, dividing the plurality of grid points into a plurality of included points and a plurality of excluded points, and determining a set of AP vicinity information for the plurality of grid points. In one example, the plurality of included points are proximate to the area of interest. In another example, the plurality of included points reside inside the area of interest. In one example, one or more of the plurality of excluded points correspond to inaccessible locations.

The method further includes, compressing the set of AP vicinity information based on the rectangular array of grid points, and providing the compressed set of AP vicinity information and a sequence to a mobile device. In one example, the compression uses an image based compression technique, such as JPEG. The sequence distinguishes the plurality of included points from the plurality of excluded points.

The method further includes, generating the sequence based on a number of consecutive included grid points and a number of consecutive excluded grid points according to a scanning order. In one example, the scanning order includes scanning the rectangular array of grid points in one direction starting from a grid point residing on a corner of the rectangular array.

In one example, the method further includes, in part, providing one or more characteristics of at least one of the rectangular array of grid points and the plurality of grid points. In one example, the rectangular array of grid points includes, in part, rows of grid points and columns of grid points. The one or more characteristics includes at least one of a location of a corner of the rectangular array, an orientation of the rectangular array, an inter-grid point spacing, a number of grid points in each row of grid points, and number of grid points in each column of grid points, and any other characteristics. In one example, the one or more characteristics further comprise the angle.

In one example, determining the set of AP vicinity information for the plurality of grid points includes assigning dummy values to the excluded points.

A method for obtaining access point (AP) vicinity information is disclosed. The method includes, in part, receiving a compressed set of AP vicinity information and a sequence from a device. The sequence distinguishes a plurality of included points from a plurality of excluded points in a plurality of grid points forming a predefined shape, and the plurality of included points are proximate to an area of interest. The method further includes, in part, determining the set of AP vicinity information by decompressing the compressed set of AP vicinity information based on a rectangular array of grid points, determining the plurality of grid points based on the rectangular array of grid points, mapping the set of AP vicinity information to the plurality of grid points based at least on the sequence, and storing the mapped AP vicinity information. In one example, the plurality of included points reside inside the area of interest. In one example, one or more of the plurality of excluded points correspond to inaccessible locations.

In one example, mapping the set of AP vicinity information to the plurality of grid points includes, in part, identifying each grid point in the rectangular array of grid points as an included or excluded grid point based on the sequence, mapping the set of AP vicinity information to the included grid points in the rectangular array, and mapping the rectangular array of grid points into the plurality of grid points.

In one example, the sequence includes, in part, a number of consecutive included grid points and a number of consecutive excluded grid points according to a scanning order. In one example, the scanning order includes, in part, scanning the rectangular array of grid points in one direction starting from a grid point residing on a corner of the rectangular array.

In one example, the method further includes, in part, receiving one or more characteristics of at least one of the rectangular array of grid points and the plurality of grid points from the device.

In one example, the rectangular array of grid points includes, in part, rows of grid points and columns of grid points and the one or more characteristics includes, in part, at least one of a location of a corner of the rectangular array, an orientation of the rectangular array, an inter-grid point spacing, a number of grid points in each row of grid points, and number of grid points in each column of grid points.

In one example, the predefined shape corresponds to the rectangular array and the plurality of grid points corresponds to the rectangular array of grid points.

In another example, the predefined shape resembles a parallelogram, the one or more characteristics further comprise an angle and the plurality of grid points corresponds to a transformation of the rectangular array of grid points based on the angle.

In one example, an apparatus for providing access point (AP) vicinity information is disclosed. The apparatus includes, in part, at least one processor and a memory coupled to the at least one processor. The at least one processor is configured to define a rectangular array of grid points, determine a plurality of grid points based on the rectangular array of grid points. The plurality of grid points overlay an area of interest and form a predefined shape. The at least one processor is further configured to divide the plurality of grid points into a plurality of included points and a plurality of excluded points. The plurality of included points are proximate to the area of interest. The at least one processor is further configured to determine a set of AP vicinity information for the plurality of grid points, compress the set of AP vicinity information based on the rectangular array of grid points, and provide the compressed set of AP vicinity information and a sequence to a mobile device. The sequence distinguishes the plurality of included points from the plurality of excluded points.

In one example, an apparatus for obtaining access point (AP) vicinity information is disclosed. The apparatus includes, in part, at least one processor and a memory coupled to the at least one processor. The at least one processor is configured to receive a compressed set of AP vicinity information and a sequence from a device. The sequence distinguishes a plurality of included points from a plurality of excluded points in a plurality of grid points forming a predefined shape, and the plurality of included points are proximate to an area of interest. The at least one processor is further configured to determine the set of AP vicinity information by decompressing the compressed set of AP vicinity information based on a rectangular array of grid points, determine the plurality of grid points based on the rectangular array of grid points, map the set of AP vicinity information to the plurality of grid points based at least on the sequence, and store the mapped AP vicinity information.

In one example, an apparatus for providing access point (AP) vicinity information is disclosed. The apparatus includes, in part, means for defining a rectangular array of grid points, and means for determining a plurality of grid points based on the rectangular array of grid points. The plurality of grid points overlay an area of interest and form a predefined shape. The apparatus further includes, in part, means for dividing the plurality of grid points into a plurality of included points and a plurality of excluded points. The plurality of included points are proximate to the area of interest. The apparatus further includes, in part, means for determining a set of AP vicinity information for the plurality of grid points, means for compressing the set of AP vicinity information based on the rectangular array of grid points, and means for providing the compressed set of AP vicinity information and a sequence to a mobile device. The sequence distinguishes the plurality of included points from the plurality of excluded points.

In one example, an apparatus for obtaining access point (AP) vicinity information is disclosed. The apparatus includes, in part, means for receiving a compressed set of AP vicinity information and a sequence from a device. The sequence distinguishes a plurality of included points from a plurality of excluded points in a plurality of grid points forming a predefined shape. The plurality of included points are proximate to an area of interest. The apparatus further includes, in part, means for determining the set of AP vicinity information by decompressing the compressed set of AP vicinity information based on a rectangular array of grid points, means for determining the plurality of grid points based on the rectangular array of grid points, means for mapping the set of AP vicinity information to the plurality of grid points based at least on the sequence, and means for storing the mapped AP vicinity information.

### BRIEF DESCRIPTION OF THE DRAWINGS

An understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a wireless communication network, in accordance with certain embodiments of the present disclosure.

FIG. 2 illustrates an example reference grid with an example heat map area, in accordance with certain embodiments of the present disclosure.

FIG. 3 illustrates an example radio frequency heat map area including grid points, in accordance with certain embodiments of the present disclosure.

FIGS. 4A and 4B illustrate two example rectangular heat maps overlaying areas with inefficient overlay of grid points.

FIGS. 5A and 5B illustrate two example scanning orders for grid points, in accordance with certain embodiments of the present disclosure.

FIG. 6 illustrates an example heat map encoding, in accordance with certain embodiments of the present disclosure.

FIG. 7 illustrates an example reorientation of a heat map area with rows shifted in the positive X direction, in accordance with certain embodiments of the present disclosure.

FIG. 8 illustrates an example reorientation of a heat map area with columns shifted in the positive Y direction, in accordance with certain embodiments of the present disclosure.

FIG. 9 illustrates example operations that may be performed by a device to provide a heat map, in accordance with certain embodiments of the present disclosure.

FIG. 10 illustrates example operations that may be performed by a mobile device to utilize heat map information, in accordance with certain embodiments of the present disclosure.

FIG. 11 illustrates an example RF heat map for an area with a complex shape that can be defined using runs of grid points, according to one embodiment.

FIG. 12 illustrates example operations that may be performed by a device to provide AP vicinity information, in accordance with certain embodiments of the present disclosure.

FIG. 13 illustrates example operations that may be performed by a mobile device to obtain AP heat map information, in accordance with certain embodiments of the present disclosure.

FIG. 14 describes one potential implementation of a device which may be used to provide and/or utilize a heat map, according to certain embodiments.

### DETAILED DESCRIPTION

Certain embodiments of the present disclosure provide a method for efficiently aligning vicinity information (e.g., Wi-Fi or Bluetooth radio frequency (RF) heat map data) of an access point (AP) to actual building geometry. The AP vicinity information may generally relate to any information that is dependent on geographic location (e.g., a geographic location matching one among a set of grid points) within the vicinity of the AP. For example, the vicinity information may include AP radio signal strength indication information (e.g., mean RSSI or RSSI standard deviation), AP round trip propagation time values (e.g., mean RTT or RTT standard deviation), or any data related to RF signal transmission from the AP that can be calculated or measured for a location close to the AP. The information may be in the form of mean values, standard deviation values and/or other statistics. In one embodiment, the AP vicinity information may be used in obtaining a location fix for a mobile device in an indoor environment. Generally, a location fix is a position derived from measuring signals transmitted from identifiable transmitters at known or unknown locations.

As used herein, the term “access point” includes any wireless communication station and/or device, typically installed at a fixed terrestrial location and used to facilitate communication in a wireless communications system. For example, an access point may comprise a wireless local area network (WLAN) access point, a cellular base station, Macro cell, Macro base station, Pico cell, Pico base station, Femto cell, Femto base station, eNode B, Node B, home NodeB or the like. The AP may support wireless communication and transmission according to any of a number of different wireless communication standards such as Global System for Mobile Communications (GSM), Wideband Code Division Multiple Access (WCDMA), Long Term Evolution (LTE), Wi-Fi, Bluetooth, code division multiple access 2000 (cdma2000) or some other standard. Wireless communication using GSM, WCDMA and LTE is defined by an organization known as the 3^{rd} Generation Partnership Project (3GPP). Wireless communication according to cdma2000 is defined by an organization known as the 3^{rd} Generation Partnership Project 2 (3GPP2) and wireless communication using Wi-Fi is defined by the Institute of Electrical and Electronics Engineers (IEEE).

As used herein, the terms “user equipment” (UE), “device” or “mobile device” may be used interchangeably to refer to a device that may from time to time have a position location that changes. For example, a mobile device may comprise a cellular telephone, smartphone, tablet, wireless communication device, mobile station, laptop computer, a personal communication system (PCS) device, Secure User Plane Solution (SUPL) Enabled Terminal (SET), personal digital assistant (PDA), personal audio device (PAD), portable navigational device, and/or other portable communication devices.

As used herein, the term “heat map value” may be used interchangeably with the term “signaling characteristic” to refer to a signaling characteristic such as RSSI or RTT for a particular AP, Femto cell or BS at some location such as at one grid point within a rectangular array or other plurality of grid points. The term “heat map” may be used interchangeably with the term “AP vicinity information” to refer to a set of heap map values (which may be encoded and/or compressed) for a set of known or defined locations such as a set of grid points forming a rectangular array or some other shape such as a parallelogram.

Certain embodiments present techniques for aligning heat map information with actual geometries of an area of interest and providing the heat map information to a mobile device (e.g., user equipment). In one embodiment heat maps are defined using consecutive runs of included and excluded grid points. In general, consecutive runs of grid points can be used to describe a heat map area with any arbitrary shape, and/or indicate inaccessible locations in an area. Having a knowledge about inaccessible locations may help to avoid locating a device in such inaccessible locations.

In one embodiment, the heat maps may be used by a mobile device to determine its location. While the vicinity information is described for WLAN or Wi-Fi APs, the same method of representing the information may be used for other transmitters such as cellular BSs, small cells and small BSs, Bluetooth APs, and the like without departing from the teachings of the present disclosure.

Generally, AP vicinity information (also referred to as an RF heat map, or a heat map) is a graphical representation of data where the individual RF signal characteristics (e.g., mean RSSI, mean RTT and the like) are contained in a matrix associated with a set of grid points such as a set of grid points containing rows and columns corresponding to a rectangle. The AP vicinity information may be depicted with a set of colors and/or numbers. As an example, the magnitude of a signal characteristic at any grid point may be represented by a specific color around that grid point, or a specific number associated with the grid point.

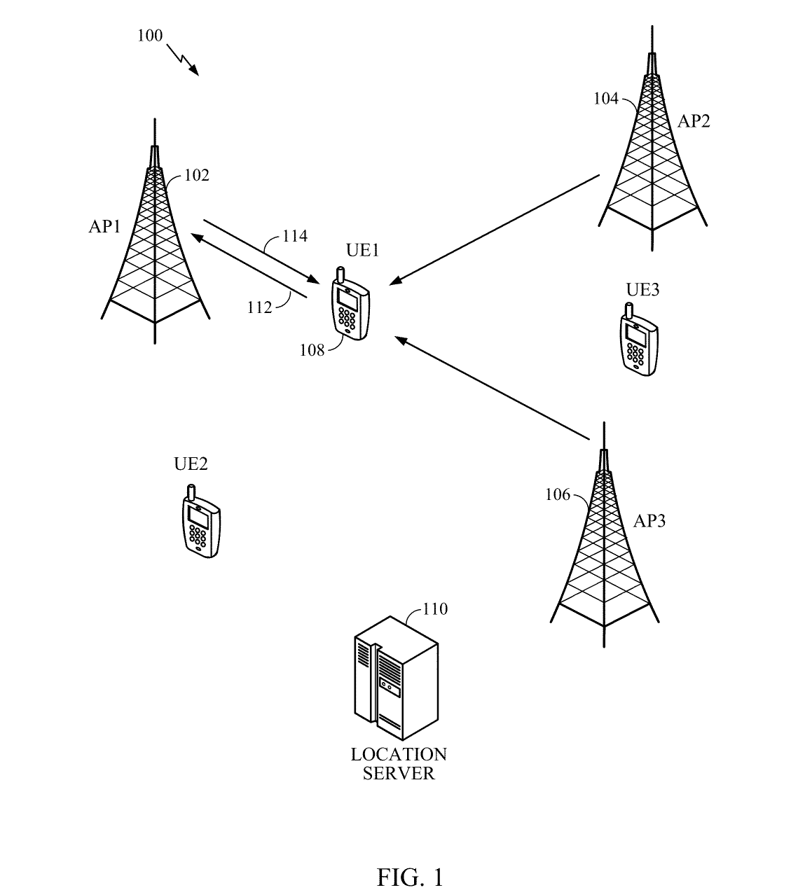

FIG. 1 illustrates a wireless communication network 100, in accordance with certain embodiments of the present disclosure. As illustrated, the network 100 may include a plurality of access points (e.g., AP1 102, AP2 104, AP3 106) and user equipments (e.g., UE1 108, UE2, UE3). In addition, the network 100 may include or provide access to a location server (LS) 110. UE1 communicates with its serving access point (e.g., AP1 102) through a forward link 112 and a reverse link 114. UE1 may also receive signals from other access points (e.g., AP2 104 and/or AP3 106). It should be noted that although only a few UEs and APs, and only one LS are illustrated in FIG. 1, any number of these devices may be available in the network or (in the case of an LS) may be accessible from the network.

Location server 110 stores and/or determines signal strength information and/or timing information corresponding to different access points (e.g., Wi-Fi heat maps) for a grid of points specific to each access point. LS 110 provides this information to the UEs and/or other devices. In general, each of the access points may have a grid of points associated with it that may span a horizontal geographic area corresponding to the overall wireless coverage area of the access point. If an access point can provide wireless coverage to several floors of a multi-story building (e.g., the floor on which the access point is located as well as the floor immediately above and the floor immediately below this floor), the access point may have a separate grid a points for each floor for which wireless coverage can be provided where the grid of points for each floor corresponds roughly to the geographic area for the floor within which wireless coverage by the access point can be provided.

Signals transmitted by an access point may be measured by a device (e.g., by UEs such as UE1, UE2 and UE3 and/or by other mobile devices), with the measurements provided to the LS 110 to enable the LS 110 to compute a location for the device based on the measurements. Alternatively, location server 110 or another device may generate one or more heat maps by computing expected signal measurements corresponding to each AP for the set of grid points or for each of the sets of grid points associated with the AP based on a local building layout, a known AP location, known RF propagation laws, and other characteristics. The heat maps may be stored in the LS or any other nodes in a wireless communication system and provided to the UEs in the vicinity of the APs. In addition or as an alternative, location server 110 may receive measurements of AP signals (e.g., measurements of RSSI and/or RTT) for one or more APs from one or more UEs at known locations, where the locations of the UEs are also provided to the location server 110. The known locations of the UEs may be obtained by each UE (or by the location server 110) using position methods not dependent on the signals measurements for the APs. For example, the known UE locations may be obtained using GNSS measurements obtained by each UE and may be updated as the UE moves to other locations using additional GNSS measurements. Alternatively or in addition, a new location for a UE may be obtained using measurements obtained by inertial sensors (e.g., accelerometers, gyroscopes, magnetometers and/or barometers inside each UE) which may suffice to determine a change in location for a UE and thereby update a previous location that was obtained using GNSS. A location server 110 may use the measurements (e.g., of RSSI and/or RTT) received for each AP from UEs at different known locations to create, update and/or validate a heat map of signal measurements (e.g., for RSSI and/or RTT) corresponding to a grid of points (or several grids of points) overlaying the coverage area (or coverage areas) for the AP.

Generally, a heat map for an AP is defined based on a set of grid points arranged (e.g., in a rectangular shape) relative to a horizontal X,Y coordinate system, which may have any orientation relative to a fixed North-South-East-West coordinate system. The X,Y coordinate system plus a grid point spacing (which provides a unit of length) may be used (e.g., by a location server such as LS 110) to define a common reference grid for most or all of the heat maps for a set of APs that provide wireless coverage in some common area or volume (e.g., such as an office building, apartment building, airport, convention center). The common reference grid may contain one grid point at the origin of the X,Y coordinate system and additional grid points at every location in the X,Y coordinate system that has integer X and Y coordinates, where the common grid point spacing provides the unit of length for the X and Y coordinates. Thus, for example, there may be grid points for locations with coordinates (X=1, Y=1), (X=2, Y=2) etc. but not at locations where an X or Y coordinate is not an exact integer. An individual heat map for a particular Wi-Fi AP (or a Femto cell) in a particular building or area may then be defined by a rectangle. The location, length and width of the rectangle can be defined using the common reference grid. For example, a rectangular set of grid points within the common reference grid may be defined by specifying integer X and Y coordinate values of one corner of the rectangle (e.g., the corner with minimum X and Y coordinate values) as well as the number of grid points in the common reference grid that appear inside the rectangle in the X and Y directions. Data corresponding to each heat map (e.g., mean RSSI, mean RTT) may then be provided for each grid point within the rectangular heat map area as a sequence of bits or octets. The heat map data may optionally be compressed using a compression method, such as JPEG.

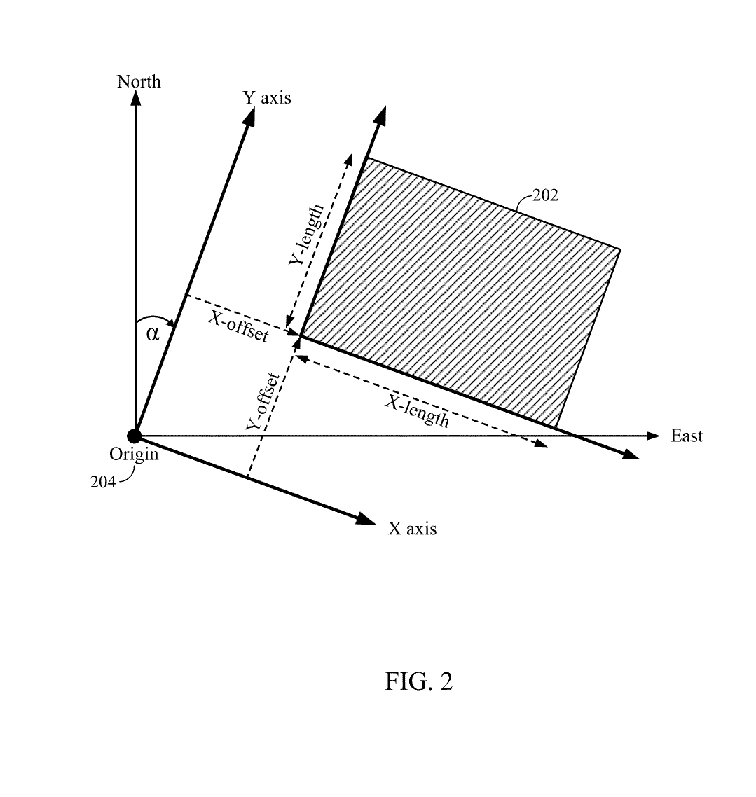

FIG. 2 illustrates an example reference grid with an example heat map area 202. The RF heat map area 202 is defined relative to a reference grid. The reference grid may correspond to the common reference grid described previously and in the example in FIG. 2 is a two dimensional horizontal X,Y coordinate system with a given origin 204, given orientation α and given grid point spacing (not shown in FIG. 2). The origin 204 of the X,Y coordinate system may coincide with one grid point and may be defined as a location relative to a reference point (e.g., a location that coincides with a reference point or a location that is North (or South) of the reference point by a given distance and East (or West) of the reference point by another given distance). The reference point may be a point with a predefined location, such a predefined latitude and longitude, or a point with a predefined position on a map or on a building floor plan (e.g., the center of an entrance to a building or particular corner of a building). The orientation a may represent a clockwise (or counter-clockwise) angle between North (or East, West or South) and the Y axis (or X axis). X and Y coordinates may be restricted to integers based on the common grid spacing (e.g., where a Y coordinate of 1 corresponds to locations with a perpendicular distance equal to the common grid point spacing from the X axis). The grid spacing may be defined as a distance between adjacent grid points in X and/or Y directions. The area of a heat map area 202 may be defined as a rectangle with sides parallel to the X and Y axes. The location of the heat map area 202 may be defined by the X and Y coordinates (denoted X-offset and Y-offset in FIG. 2) of the corner of the rectangle with minimum X and Y coordinates, where the X and Y coordinates may be restricted to be integers to ensure that the corner of the rectangle with minimum X and Y offsets coincides with a grid point. The size of the heat map may be defined by the length of each side of the rectangle (denoted X-length and Y-length in FIG. 2) in units of the common grid spacing where both lengths may be integers to ensure that the other corners of the rectangle coincide with grid points and that each side of the rectangle aligns with a set of grid points parallel to the X or Y axis.

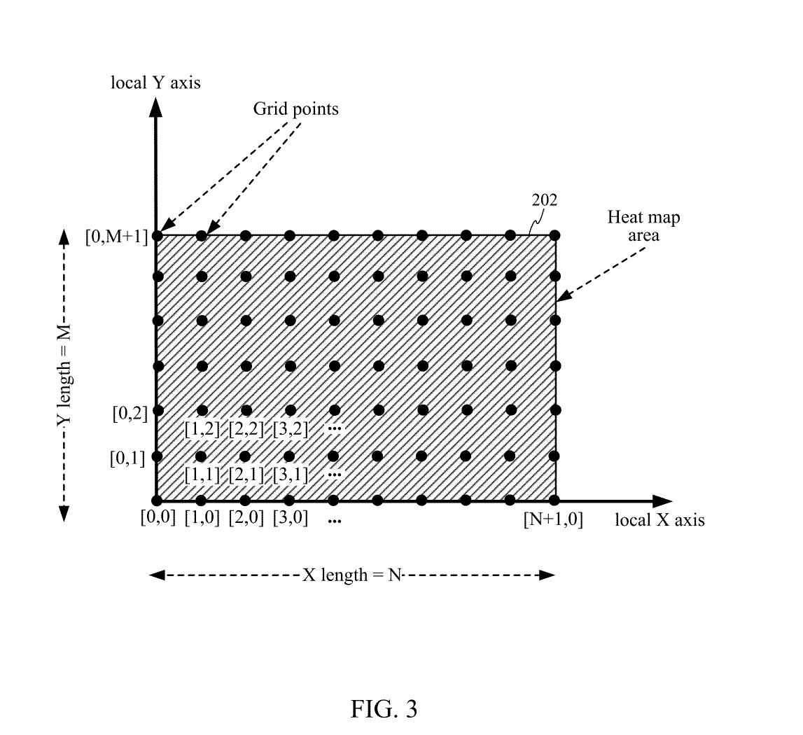

FIG. 3 illustrates an example RF heat map area including grid points which may correspond to heat map area 202 on FIG. 2. In this example, the length of the heat map in the X direction is represented by a positive integer N, and length of the heat map in the Y direction is represented by a positive integer M. As a result, the heat map area contains (N+1)×(M+1) grid points. Grid points align with integer X and Y coordinates in the reference grid and may be given local coordinates relative to the corner of the rectangle with minimum X,Y coordinates in the reference grid (as shown in FIG. 3). Heat map data (e.g., mean RSSI, mean RTT) are measured and/or calculated for each of the grid points.

Once a common reference grid has been defined (or is known in some way), a heat map area, such as heat map area 202 in FIGS. 2 and 3, that contains a plurality of grid points in the common reference grid, may be referred to as an array of grid points, a grid point array or, when the shape is rectangular as FIGS. 2 and 3, as a rectangular array or a rectangular array of grid points. It should be understood that a grid point array or array of grid points may overlay a heat map area and vice versa making the differing names synonymous.

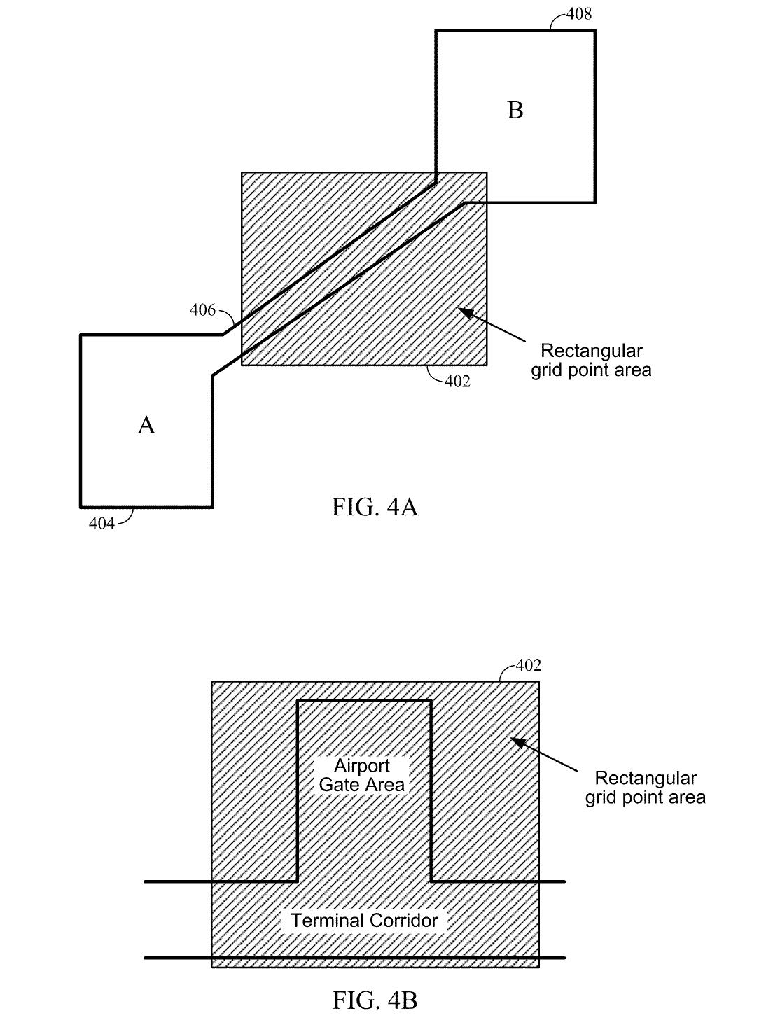

Generally speaking, the rectangular heat map definition may have some limitations. For example, a rectangular area (e.g., fixed X,Y coordinate system with a fixed orientation) may not always align well with different parts of a building and/or with different building and room geometries. For example, a connecting corridor or a connecting gate in an airport may not align with a rectangular heat map (as illustrated in FIGS. 4A and 4B). However, despite misalignment, a rectangular area may be a fairly good fit to the overall RF coverage area of an AP. Hence, indoor areas are conventionally overlaid with rectangular heat map areas. However, a substantial amount of the heat map area may not cover the area of interest (e.g., the indoor area). This may result in poor compression of the heat map data and possibly waste of resources, such as signaling bandwidth and/or memory.

FIGS. 4A and 4B illustrate two example rectangular heat maps with inefficient overlay of grid points on the areas of interest. FIG. 4A illustrates a rectangular heat map 402 overlaying a corridor (or bridge) 406 between rooms A 404 and B 408 of a building. As can be seen, only a fraction of the grid points cover the area of interest (e.g., corridor 406). Similarly, FIG. 4B illustrates a rectangular heat map 402 that inefficiently overlays a gate and part of a corridor in an airport terminal. As can be seen, only a portion of the rectangular heat map covers the gate and the corridor.

Encoding Heat Map Values without Compression

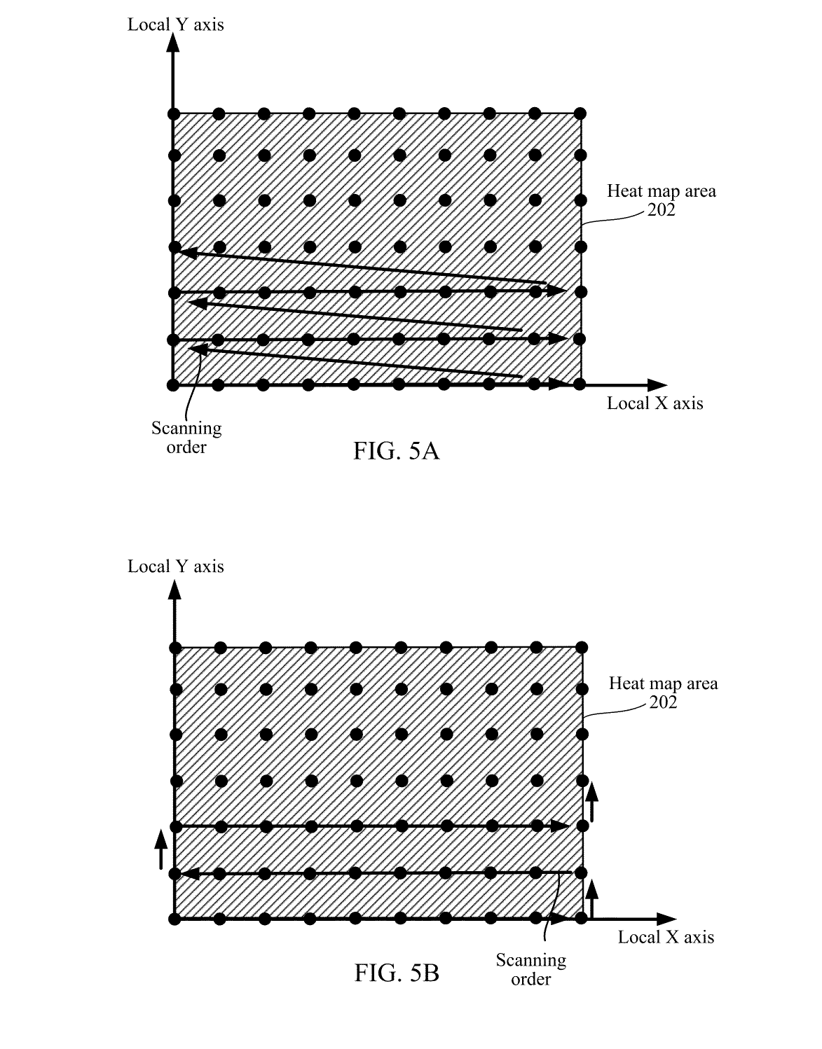

In one embodiment, heat map values may each be encoded using a single octet, containing an integer value between 0 and 255. The relationship of each encoded value to the RF-related statistic (e.g., mean RSSI and/or mean RTT) may be defined in advance (e.g., an encoded value of N for RSSI might represent an RSSI value of N-128 in units of dBm). Encoded values may be provided as an octet string for successive grid points within a rectangular heat map area using a scanning order, such as the scanning orders in FIGS. 5A and 5B. The scanning order refers to an order in which grid points are encountered or “scanned”, where the scanning of each grid point corresponds to adding one or more octet values corresponding to an RF related statistic (e.g., mean RSSI or mean RTT) to the octet string. Once all grid points in a heat map area have been scanned, the resulting octet string may be used to represent all the heat map values within the heat map area—e.g., may be further compressed into a smaller octet string (e.g., using JPEG compression) and/or may be transmitted (as an uncompressed octet string) to some other entity in order to transfer the heat map content.

FIGS. 5A and 5B illustrate two example scanning orders for a set of grid points within a rectangular heat map area (such as heat map area 202 in FIGS. 2 and 3), in accordance with certain embodiments of the present disclosure. In the scanning order shown in FIG. 5A, scanning begins at the grid point with minimum X and Y coordinates in the set of grid points, and proceeds to subsequent grid points along the local X axis (e.g., row of grid points). When the last grid point within the heat map area along the local X axis is reached, scanning resumes again from low X to high X for the next row of grid points (e.g., grid points with Y coordinates equal to the Y coordinates of the previous row plus one). This continues until all the grid points with maximum Y coordinates in the heat map area are scanned from low X to high X.

FIG. 5B illustrates an alternate scanning order for the set of grid points. As illustrated, scanning begins at the grid point with minimum X and Y coordinates in the set of grid points and proceeds to subsequent grid points along the local X axis. When the last grid point within the heat map area along the local X axis is reached, scanning resumes from high X to low X for grid points in the next row (e.g., subsequent Y coordinates). This continues until grid points with maximum Y coordinates in the heat map area are scanned from either low X to high X, or high X to low X.

It should be noted that the embodiments as described herein may operate with any scanning order. FIGS. 5A and 5B only show two example scanning orders, but other orders are possible too (e.g., scanning along columns of grid points in the Y direction rather than along rows of grid points in the X direction). The scanning order may be predefined for the devices that encode and/or decode the information corresponding to the grid points.

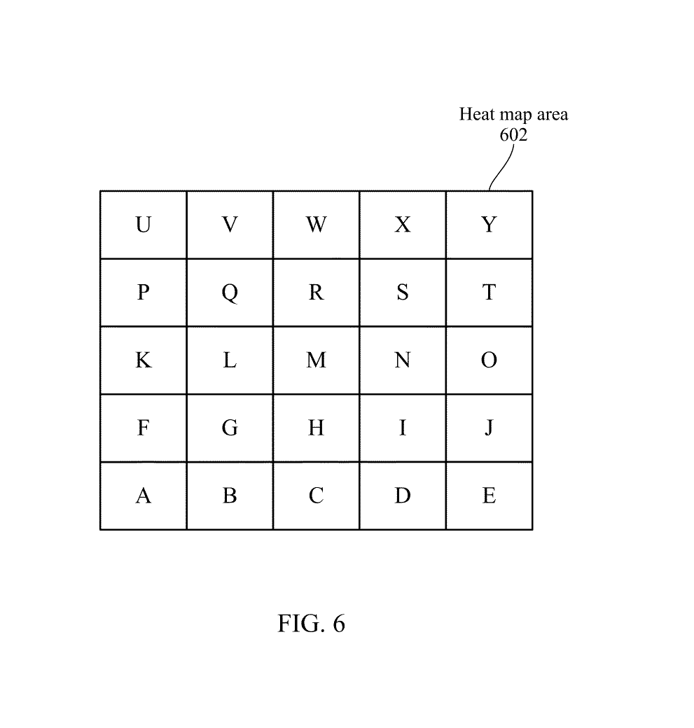

FIG. 6 illustrates an example heat map encoding, in accordance with certain embodiments of the present disclosure. A heat map area 602 of size 5 by 5 units is illustrated, where the letter within each square represents the encoded value of one particular signal statistic (e.g., mean RSSI or mean RTT) at a grid point centered within the square. As an example, the octet string that would be produced following scanning of the grid area shown in FIG. 6 using the scanning order shown in FIG. 5A would be the alphabetic sequence A, B, C, D, E, F, G . . . X, Y. As another example, if the scanning order shown in FIG. 5B is used, the scanned sequence would be A, B, C, D, E, J, I, H, G, F, K, L, M, N, O, T, S, R, Q, P, U, V, W, X, Y.

Encoding of a Heat Map with Compression

In one embodiment, a heat map containing a rectangular grid of points with a certain signal characteristic (e.g., RSSI or RTT) associated with each grid point may be compressed using known compression techniques. For example, two-dimensional image-based compression techniques such as JPEG may be used to compress the heat map data. Each of the grid points may be associated with an octet of data that represents a common signal characteristic (e.g., RSSI or RTT) at that grid point. The octet values for nearby grid points may be strongly correlated with one another due to the tendency of a signal characteristic to change only slowly with small changes in location. Therefore, a standard JPEG compression library may be used to efficiently compress the two-dimensional array of encoded octet values using the known X and Y lengths of the heat map area. The resulting compressed heat map information may then be used and/or transmitted to one or more devices. The receiving device may decompress the heat map information before use to retrieve uncompressed data. In one example, the receiver may also use standard JPEG decompression routines. Since the compression and/or decompression result in small errors, the compressing device may limit the amount of compression.

One method to enable more efficient overlay of actual building areas with heat maps is to define heat maps using more than one X, Y coordinate system. For example, in the building shown in FIG. 4A, a different X, Y reference grid can be used with the X or Y axis aligned to the direction of the corridor. This way, a rectangle could be used with a close fit to the area covered by the corridor. However, having more than one X, Y reference grid would mean misalignment of grid points in areas where coverage of several APs defined according to two or more different X, Y reference grids overlap. Aligning the grid points used for the heat maps of different APs may be useful or even necessary to better enable a mobile device or a server to determine a location for the mobile device by matching signal characteristics for the APs measured by the mobile device with the signal characteristics defined by the heat maps. If grid points do not align, it may be more difficult to compare signal characteristics for different APs for precisely the same locations.

Another method would be to use a single X, Y reference grid to maintain common grid points for all heat maps and change the rectangular shape of a heat map. Arbitrary shapes could be defined containing reference grid points (e.g., a rectangle with any orientation, circle, ellipse, etc.) but defining and using these shapes would add complexity since the shapes would need to be defined in some way which would require additional information as well as a capability to create and interpret this information. However, allowing a limited number of additional shapes that can be defined using very little additional information may be used efficiently as described next herein.

### Non-Rectangular Heat Maps

Non-rectangular heat maps conforming to certain rules described later herein may be used to overlay areas of interest with arbitrary shapes more efficiently. For example, areas that are not aligned with fixed X and Y directions for a rectangular grid may be overlaid with the non-rectangular heat maps. One embodiment enables reorientation of a rectangular area to better match an area of interest. As an example, the rectangular heap may be reoriented to form a shape resembling a parallelogram. Generally speaking, reorienting a heat map area (e.g., into a parallelogram) may allow orientation of the heat map with arbitrary building directions—e.g., the corridor 406 in FIG. 4A. One of the advantages of reorienting heat maps to non-rectangular forms, as described herein, is that the new area only adds one new parameter (e.g., an angle θ with which the rectangular map is skewed into a parallelogram). Depending on the area of interest, this method can significantly increase heat map efficiency.

For certain embodiments, a common reference grid with a common grid point spacing may be used for different APs, thereby avoiding multiple non-overlapping reference grids. It should be noted that the embodiments described herein can be used separately, or in combination without departing from the teachings of the present disclosure. In addition, the embodiments described herein may be combined with other encoding and/or compression techniques.

### Reorientation of a Heat Map

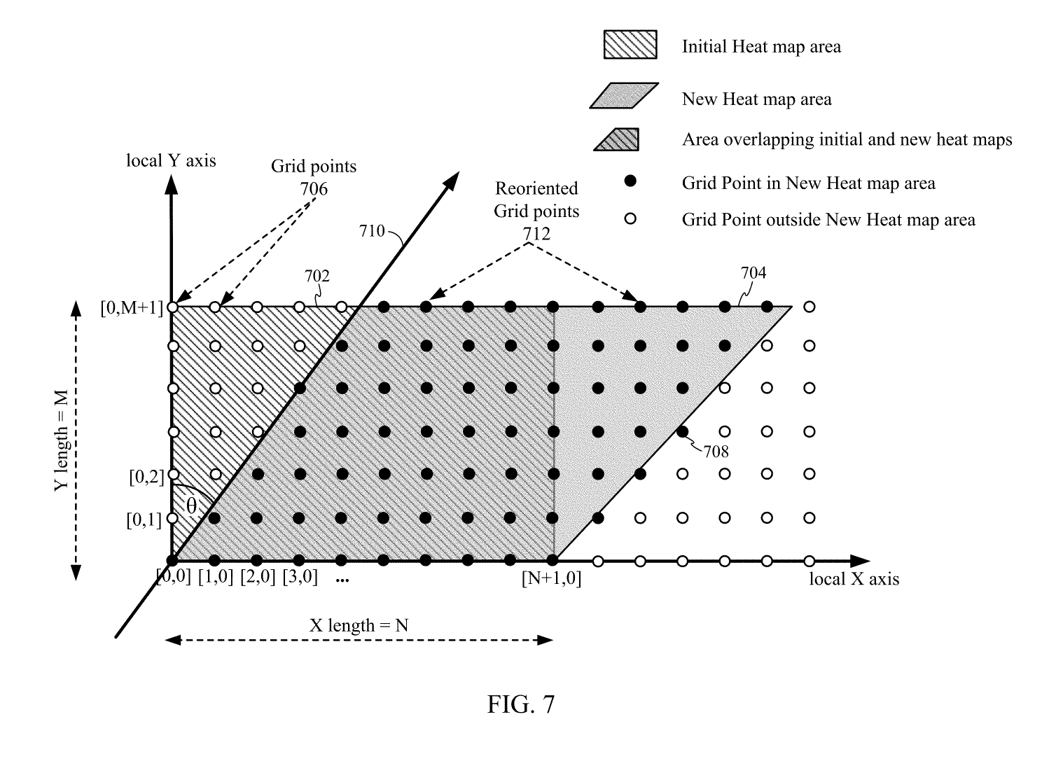

To support arbitrary reorientation of a heat map, an initial heat map area 702 composed of a rectangular array of grid points may first be defined (as shown in FIG. 7). In one embodiment, consecutive grid points may have equal distance from each other. In one embodiment, a straight line 710 through the local origin of the heat map at a clockwise angle θ to the local Y axis may be defined with −90°≦θ≦90°. Grid point rows (e.g., grid points parallel to the local X axis) in the initial heat map area may then be shifted in the positive X direction when θ is positive (as shown in FIG. 7) or in the negative X direction when θ is negative (not shown in FIG. 7) by an integer number of inter-grid point units of distance, such that each row starts at a grid point that is located either on the straight line 710 or just to the positive X side (e.g., right) of the line.

FIG. 7 illustrates an example reorientation of a heat map area with rows shifted in the positive X direction, in accordance with certain embodiments of the present disclosure. As illustrated, an initial heat map area 702 with a shape resembling a rectangle is considered. The grid points 706 of the rectangular heat map area 702 are arranged in M+1 rows and N+1 columns, where M is the length of the rectangular area parallel to the Y axis and N is the length parallel to the X axis, both in units of the common inter-grid point spacing. As described earlier, and as shown in FIG. 7, the grid points 706 in the rectangular heat map area 702 (also referred to herein as a rectangular array of grid points) may be shifted in a positive X direction to overlay a new heat map area resembling a parallelogram 704. The new reoriented heat map area (also referred to herein as a reoriented array of grid points) still contains M+1 rows of grid points parallel to the X axis. In one embodiment, each row of the reoriented heat map still contains an equal number of grid points, equal to N+1 in this example.

As shown in FIG. 7, all of the reoriented grid points 712 for the new heat map area may not fit exactly inside the parallelogram 704, but, the reoriented grid points 712 may still resemble the parallelogram 704. For example, some of the reoriented grid points (e.g., such as the grid point 708) may be located slightly outside the parallelogram 704, but close to the edges of the parallelogram 704. In general, most of the reoriented grid points may be located inside the parallelogram 704. In this case, it is said that the grid points in the reoriented heat map area form a shape resembling a parallelogram.

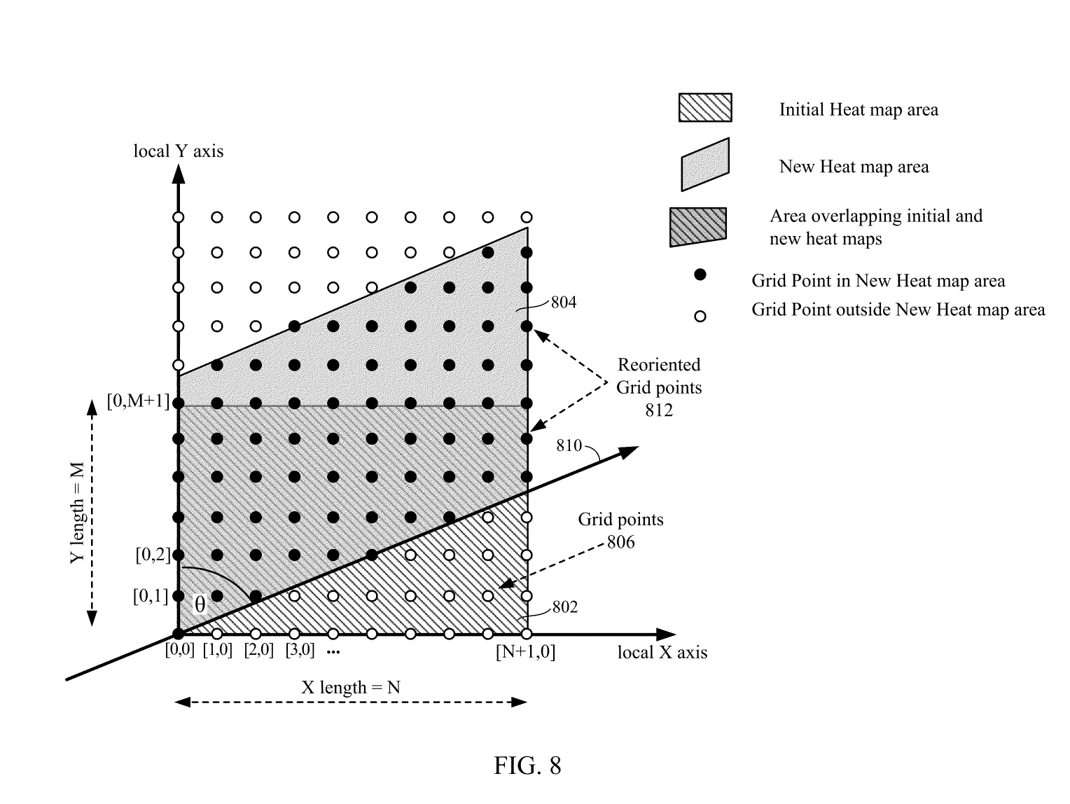

FIG. 8 illustrates another example reorientation of a heat map area composed of a rectangular array of grid points. Similar to FIG. 7, an initial heat map area 802 with a shape resembling a rectangle is considered. The grid points 806 of the rectangular heat map area 802 are again arranged in M+1 rows and N+1 columns, where M is the length of the rectangular area parallel to the Y axis and N is the length parallel to the X axis, both in units of the common inter-grid point spacing. In one embodiment, a straight line 810 through the local origin of the heat map at a clockwise angle θ to the local Y axis may be defined with −90°≦θ≦90°. However, in FIG. 8, columns of grid points 806 are shifted in the positive Y direction when θ is positive (as shown in FIG. 8) and in the negative Y direction when θ is negative towards the portion of the line 810 lying below the X axis (not shown in FIG. 8), in accordance with certain embodiments of the present disclosure. As illustrated, grid point columns (e.g., grid points parallel to the local Y axis) are shifted in the positive (or negative) Y direction by an integer number of inter-grid point units of distance such that each column starts at a grid point that is either located on the line 810 or just to the positive Y side of the line 810 (e.g., above it). In this example, all the columns of the reoriented grid points have equal number of grid points.

As shown in FIG. 8, the reoriented grid points 812 for the new heat map area may approximately fit inside the parallelogram 804, similar to the reoriented grid points 712 in FIG. 7 approximately fitting inside the parallelogram 704. In this case, it is said that the grid points 812 in the reoriented heat map area form a shape resembling a parallelogram. The difference between the parallelogram 704 in FIG. 7 and the parallelogram 804 in FIG. 8 is that two sides of the parallelogram 704 are parallel to the X axis whereas two sides of the parallelogram 804 are parallel to the Y axis. The remaining two sides of each parallelogram are parallel to the line 710 or 810 through the local origin. The clockwise angle θ of the line 710 or 810 relative to the local Y axis provides a direction or orientation for each parallelogram that may be used (e.g., may be varied) to align with a certain direction in a local geographic area—e.g., could be aligned with the direction of the corridor 406 in the example of FIG. 4A. This may allow one or both of parallelograms 704 and 804 (and thus one or both of associated reoriented grid points 712 and 812 that approximately fit inside each parallelogram) to better fit some geographic area of interest such as corridor 406 in FIG. 4A. It should be noted that there is no need for a perfect match between the orientation of the grid points and orientation of the area of interest. Even an approximate overlap may increase efficiency of the heat map representation.

In general, shifts of grid points in any direction (e.g., X and/or Y) may be allowed, though only one can be used for any one heat map, as illustrated in FIGS. 7 and 8. The new heat map area in each case is a shape roughly resembling a parallelogram. The new shifted grid points may allow a better fit with areas with similar orientations to the grid points (e.g., such as a room or corridor in a building with the same orientation θ), or substantially similar orientations (e.g., a room with an orientation θ₁ which is close to θ).

For certain embodiments, heat map values (e.g., RSSI) may be assigned to each grid point in the new (reoriented) heat map area using one or more octets. In one embodiment, the heat map values are assigned to each grid point using a single octet to encode values of some signaling characteristic (e.g., mean RSSI or mean RTT). The assignment may be based on the location of each grid point in the new reoriented heat map area and may not be related to the location of each grid point prior to reorientation of the heat map area. Heat map values may then be assembled into an uncompressed octet string. In one embodiment, the octet string may be generated by first shifting rows or columns of grid points in the reoriented heat map area back into the initial rectangular heat map area (e.g., using a reverse transformation to that shown in FIGS. 7 and 8). Although the grid points are shifted back into the original rectangular heat map area, the octet assigned to each grid point to encode a signaling characteristic may not be changed. Thus, grid point positions may change but the encoded values associated with each grid point may not change. The transformed (rectangular) heat map may then be scanned in a predetermined order (e.g., as shown in FIGS. 5A and 5B) to provide a string of heat map octet values. The string of heat map octet values may then be transferred to a target (e.g., a mobile device) along with the orientation θ, and an indication of whether rows or columns of grid points were shifted. In addition, characteristics of the original rectangular grid point array may also be provided to the target. Characteristics of the original rectangular grid point array may include the location of one corner, an orientation of the local X and Y axes, an inter-grid point spacing and the lengths of the rectangular grid in the local X and Y directions (e.g., in units of the inter-grid point spacing). In one embodiment, the reoriented heat map area may be transformed back into the original rectangular heat map area before compression is applied. For example, following the transformation back into the original rectangular heat map area, octet values assigned to each grid point to encode some signaling characteristic may be compressed using JPEG.

In one embodiment, to achieve a high compression ratio without significant error, for values of θ between −45° and 45°, rows of grid points may be shifted in the positive or negative X direction as described in association with FIG. 7. In this embodiment, for values of θ between −90° and −45°, and for values of θ between 45° and 90°, columns of grid points may be shifted in the positive or negative Y direction as described in association with FIG. 8. With this embodiment, neighboring grid points may remain close to each other after the initial shifting operation that transforms a rectangular heat map area into an area resembling a parallelogram and after the reverse transformation that transforms the approximate parallelogram shaped heat map area back into the original rectangular area for the purpose of conveying and possibly compressing encoded values for a signaling characteristic in the heat map. Thereby a high correlation of neighboring heat map values may be retained in the rectangular array following the reverse transformation, which may enable efficient compression—e.g., using JPEG. In addition, when this embodiment is used, it may not be necessary to convey to a recipient of an encoded heat map (e.g., a mobile device) whether rows or columns of grid points were shifted, because the provision of the clockwise angle θ will define this according to the convention described above. For example, if θ is given as 20°, then rows of grid points would have been shifted in the positive X direction and if θ is given as −70° then columns of grid points would have been shifted in the negative Y direction.

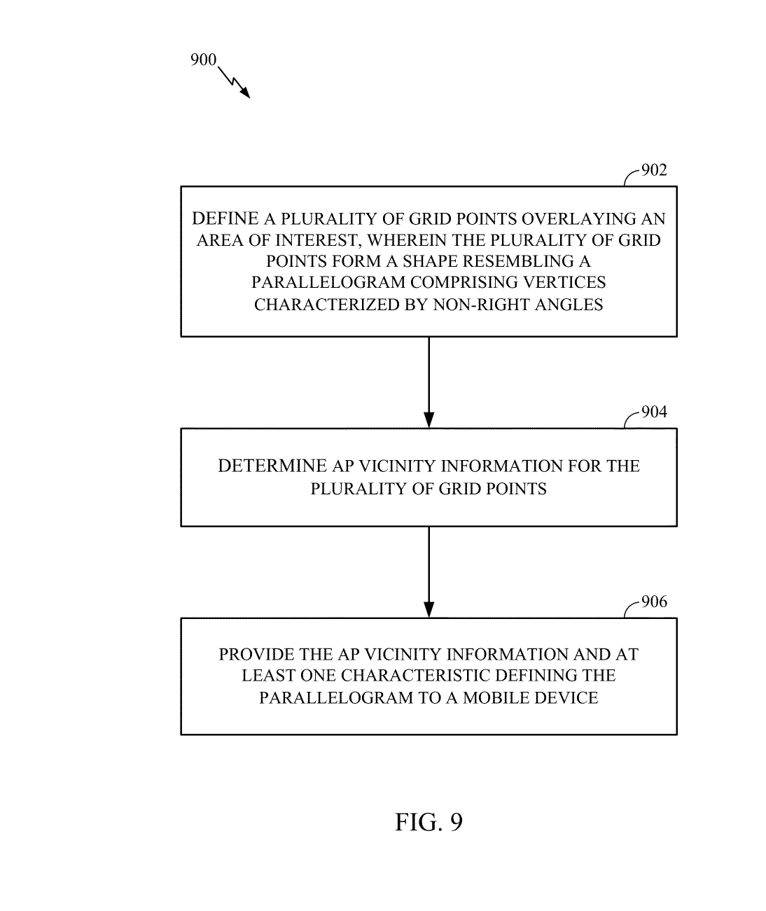

FIG. 9 illustrates example operations of a process 900 that may be performed by a device such as a location server (e.g., LS 110 in FIG. 1) to provide a heat map, in accordance with certain embodiments of the present disclosure. At 902, a plurality of grid points overlaying an area of interest may be defined. The plurality of grid points form a shape resembling a parallelogram including vertices characterized by non-right angles (e.g., angles θᵢ, 0<θᵢ<90°. or 90°<θᵢ<180°). For example, the plurality of grid points may be obtained by transforming a rectangular array of grid points as described in association with FIGS. 7 and 8. At 904, AP vicinity information is determined for the plurality of grid points. The AP vicinity information may comprise a signaling characteristic (e.g., mean RSSI or mean RTT) for a particular AP that is measured and/or computed for the location of each grid point in the plurality of grid points. The AP vicinity information may be encoded using one or more octets—e.g., may be encoded using a single octet to represent a value for a mean RSSI or mean RTT. At 906, the AP vicinity information and at least one characteristic defining the parallelogram (e.g., an angle) is provided to a mobile device. As an example, the plurality of grid points may be transformed into a rectangular array and the AP vicinity information may be scanned to produce an uncompressed octet string or may be compressed (e.g., using JPEG) into a smaller octet string with the resulting octet string being transferred to the mobile device as described previously herein (e.g., in association with the description of FIGS. 7 and 8). In one embodiment, the compressed or uncompressed AP vicinity information may be transferred to the mobile device using the LTE Positioning Protocol Extensions (LPPe) protocol defined by the Open Mobile Alliance (OMA). In one embodiment, the mobile device may use the received AP vicinity information to determine its position.

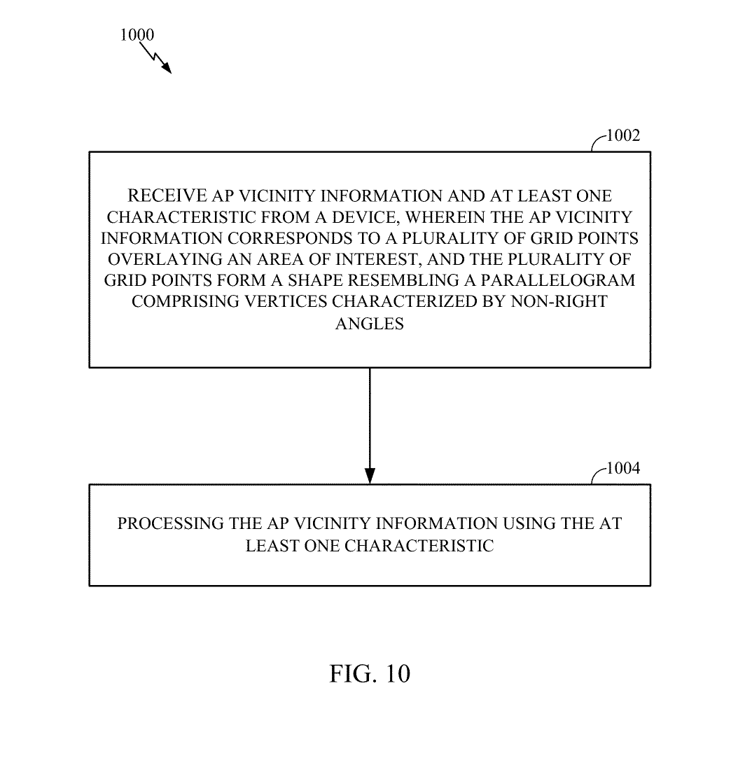

FIG. 10 illustrates example operations of a process 1000 that may be performed by a mobile device (e.g., UE1 108 in FIG. 1) to utilize AP vicinity information, in accordance with certain embodiments of the present disclosure. At 1002, the mobile device receives AP vicinity information and at least one characteristic (e.g., an angle) from a device (e.g., from a location server such as LS 110 in FIG. 1). The AP vicinity information corresponds to a plurality of grid points overlaying an area of interest. The plurality of grid points form a shape resembling a parallelogram including vertices characterized by non-right angles. The AP vicinity information may have been determined by the device using the operations exemplified in FIG. 9. At 1004, the mobile device processes the AP vicinity information using the at least one characteristic. As an example (A) of 1004, the mobile device may receive an uncompressed octet string encoding a sequence of values for some signaling characteristic (e.g., mean RSSI or mean RTT) and may perform a scanning operation that is a reverse to that exemplified in FIG. 5A or FIG. 5B in order to assign encoded values for the signaling characteristic to a rectangular array of grid points. The mobile device may then transform the rectangular array of grid points into an array of grid points resembling a parallelogram by performing a transformation as exemplified in FIG. 7 or FIG. 8 using information received from the device on an angle θ. The mobile device may further associate the encoded value for each grid point in the transformed set of grid points (now resembling a parallelogram) with a particular value for the signaling characteristic for a particular AP at the location of the grid point in the transformed set of grid points. The mobile device may use the values for the signaling characteristic for different grid points along with values for the same signaling characteristic received for heat maps conveyed by the same means for other APs to help determine the location of the mobile device using pattern matching and based on measurements of the signaling characteristic for nearby APs made by the mobile device as described earlier herein.

As another example (B) of operation 1004 in FIG. 10, the mobile device may receive a compressed octet string (e.g., using JPEG) encoding a sequence of values for some signaling characteristic (e.g., mean RSSI or mean RTT) and may perform a decompression operation that is a reverse to that performed by the device to compress the encoded values for the signaling characteristic in order to obtain uncompressed encoded values (e.g., octet values) for the signaling characteristic for a rectangular array of grid points. The mobile device may then transform the rectangular array of grid points into an array of grid points resembling a parallelogram and may associate the encoded value for each grid point in the transformed set of grid points with a particular value for the signaling characteristic for a particular AP at the location of the grid point in the transformed set of grid points as described for example (A) earlier herein. The mobile device may use the values for the signaling characteristic for different grid points to assist in positioning of the mobile device as also described for example (A) herein.

### Arbitrary Shaped Heat Maps Using Run Length Encoding

In one embodiment, referred to herein as “run length encoding”, a heat map may be efficiently defined using runs of grid points to cover areas that are arbitrarily complex. In general, an area of interest (e.g., floor plan of a building) can have any shape, including dis-contiguous portions, without departing from the teachings herein. In one embodiment, a rectangular array of grid points covering the area of interest is first defined. For example, the rectangular array may be defined as described for the heat map area 202 exemplified in FIG. 2 and FIG. 3. Each grid point in the rectangular array may then be labeled as ‘included’ or ‘excluded’. An ‘included’ grid point may refer to a grid point that falls within the area of interest or is very close to the area of interest (e.g., is very close its boundary). An ‘excluded’ grid point may refer to a grid point that is outside the area of interest or a grid point that is within the area of interest but excluded from consideration for any reason. For example, grid points that are located within the area of interest but in inaccessible locations (e.g., such us within part of a building structure) can be marked as excluded points. In addition, the grid points that are outside of the area of interest can be marked as excluded points.

For certain embodiments, to support heat maps with arbitrary shapes, a sequence of integers (e.g., integers encoded by octet values) is generated by alternating integers representing run lengths of consecutive excluded points with integers representing run lengths of included grid points. This sequence of integers may be referred to as a “run length sequence”. For example, in the run length sequence <E₁, I₁, E₂, I₂, E₃, I₃, E₄, . . . >, an integer Eᵢ (i≧1) in an odd position in the sequence may represent a number of consecutive excluded grid points, whereas an integer Iᵢ (i≧1) in an even position in the sequence may represent a number of consecutive included grid points. In some embodiments, this convention may be reversed—e.g., so that integers in odd positions represent consecutive included grid points and integers in even positions represent consecutive excluded grid points. If the grid points in a certain rectangular array are scanned in some known predefined order (e.g., such as that illustrated in FIG. 5A or FIG. 5B), the sequence of integers defining alternating numbers of included and excluded grid points can define which grid points in the scanning order are included and which are excluded from some area of interest. For example, in the case of the rectangular heat map area 602 shown in FIG. 6, the scanning order for the grid points produces the sequence A, B, C, D, E, F, G, . . . W, X, Y when the grid points are scanned using the scan order illustrated in FIG. 5A as previously described herein. If a run length sequence is defined for this scanning order comprising the integer sequence <6, 3, 2, 3, 2, 3, 6> where integers in odd positions in the sequence (e.g., 6, 2, 2 . . . ) represent runs of consecutive excluded grid points and integers in even positions (e.g., 3, 3, . . . ) represent runs of consecutive included grid points, then the included grid points would correspond to the 9 grid points G, H, I, L, M, N, Q, R, S which may correspond to an area of interest for the 3×3 inner square in the heat map area 602. It is to be noted that although in this example a rectangular grid is considered for simplicity, any known geometric shape (e.g., parallelogram, circle, ellipse, etc.) can be used instead of the rectangle without departing from the teachings of the present disclosure.

In one embodiment, a run length sequence may be provided to a mobile device in addition to AP vicinity information for some subset of grid points contained within a rectangular array of grid points. In this embodiment, the run length sequence may define which grid points are included in the subset and the subset may overlay some area of interest. This embodiment may avoid the need to transfer any AP vicinity information related to excluded grid points and may thereby reduce the amount of information that needs to be created (e.g., by a location server) and transferred to and stored by a mobile device.

In one embodiment, a rectangular array of grid points may be defined for some area (e.g., spanning part or all of a certain floor in a certain building) and information may be collected for grid points in the rectangular array that are included in some area of interest (e.g., a particular room in a building) and/or grid points that are outside the area of interest. In order to generate a heat map for the area of interest that includes AP vicinity information associated with a particular signaling characteristic for some AP such as mean RSSI or mean RTT, values for the signaling characteristic may be measured (e.g., by mobile devices located at known locations) and/or calculated (e.g., by a location server) for each of the grid points in the rectangular array as described previously herein but restricted only to grid points that are within the area of interest. The measured and/or calculated AP vicinity information could then be provided to a mobile device by providing the AP vicinity information to a mobile device only for the included grid points together with a run length sequence defining which grid points in the rectangular array are included in the area of interest.

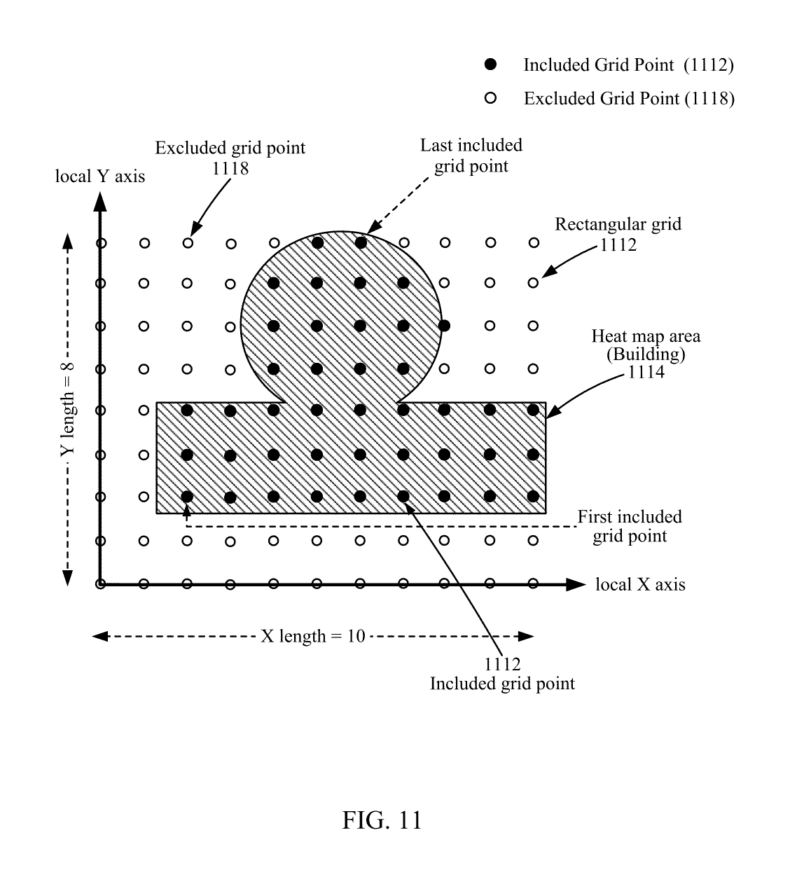

FIG. 11 illustrates an example RF heat map area 1114 for an area of interest (shown shaded in FIG. 11) with a complex shape that can be defined using a run length sequence, according to one embodiment. In the example shown in FIG. 11, the area of interest (e.g., part of a floor plan of a building) includes a circular portion and a rectangular portion. In this example, a rectangular grid 1112 of points covers a larger area (e.g., an entire floor of a building) that includes the area of interest. In this example, the rectangular grid 1112 contains ninety nine grid points, including both excluded grid points 1118 and included grid points 1120 that are within the area of interest. The heat map area 1114 is represented by the included grid points (e.g., forty two grid points out of the ninety nine grid points) that are located within the boundary of the area of interest or very close to the boundary. To define the heat map area 1114 using a run length sequence, the run length sequence can be as follows: 24, 9, 2, 9, 2, 9, 4, 4, 7, 5, 6, 4, 8, 2, 4. This run length sequence may be associated with a scanning order for the rectangular grid 1112 of points that is as defined in FIG. 5A and may start with the number of consecutive excluded grid points (e.g., here 24) followed by a number of consecutive included grid points (e.g., here 9) and so on.

In one embodiment, the integer values of consecutive included and/or consecutive excluded grid points in a run length sequence can each be encoded as a single octet with a value between 0 and 255. In one embodiment, if a number of consecutive included and/or consecutive excluded grid points is larger than 255, the number can be divided to two or more numbers that are equal to or smaller than 255. Each of the divided values can be alternated with values of 0 in the sequence. For example, if a number of consecutive excluded grid points is equal to 270, the run length sequence can include 255, 0, 15, . . . which may indicate 255 consecutive excluded grid points followed by 0 included grid points followed by 15 consecutive excluded grid points to yield a total of 270 consecutive excluded grid points. As another example, if 522 consecutive grid points are to be shown as included by a run length sequence where values in the sequence are constrained to lie in the range 0-255, the run length sequence could contain the values: 255, 0, 255, 0, 12 which can indicate a total of 255+255+12=522 consecutive included grid points. As another example, the run length sequence to indicate 522 consecutive included grid points could contain the sequence of values: 250, 0, 240, 0, 32, . . . which can also indicates a total of 250+240+32=522 consecutive included grid points.

In one embodiment, when a run length encoding technique is used to represent a heat map area, heat map values corresponding to AP vicinity information for some signaling characteristic of some AP (e.g., mean RSSI or mean RTT) can be provided to a mobile device in addition to the run length sequence defining the included and excluded grid points. In one embodiment, AP vicinity information corresponding to most or all of the grid points (e.g., included and/or excluded grid points) are provided to a mobile device and/or to a server together with a run length sequence defining which grid points are included and which grid points are excluded. In another embodiment, AP vicinity information corresponding to only included grid points are provided to other devices together with a run length sequence. In one embodiment, AP vicinity information corresponding to all of the included grid points and to some or all of the excluded grid points is provided to other devices along with a run length sequence. In these embodiments, AP vicinity information may be provided using a sequence of values (e.g., an octet sequence) where each value in the sequence encodes the value of some signaling characteristic (e.g., mean RSSI or mean RTT) calculated and/or measured for a particular grid point in a rectangular array of grid points. The run length sequence that is provided in association with the AP vicinity information may define which grid points are included and which are excluded in an area of interest and may be created using some scanning order S1 for the rectangular array of grid points. Another scanning order S2 for the rectangular array of grid points may be used to define the order in which AP vicinity information is provided for the grid points. The scanning orders S1 and S2 may each correspond to one of the scanning orders exemplified in FIGS. 5A and 5B or to some other scanning order. The scanning orders S1 and S2 may be the same or may be different. The scanning orders S1 and S2 may be predefined and known to the sender and receiver of the heat map information being transferred or may not be predefined and may be transferred as part of this heat map information.

In one example, heat map values for some signaling characteristic (e.g., mean RSSI or mean RTT) are provided to other devices (e.g., a mobile device) for included grid points in an area of interest. The order in which included grid points are selected in providing the associated heat map values may be defined by a particular scan order of the grid points for the rectangular grid point area as just described. For example, in FIG. 11, heat map values may be provided for the forty two included grid points in the heat map area 1114 according to the order in which these forty two grid points appear in a scanning order for all the grid points in the rectangular grid 1112 using the scan order exemplified in FIG. 5A. In that case, the first heat map value (e.g., in an octet sequence) would be provided for the grid point at the bottom left of the heat map area 1114 (which has X,Y coordinate values of [2,2]) and the last heat map value would be provided for the grid point at the top right of the heat map area 1114 (which has X,Y coordinate values of [6,8]).

In one embodiment, in addition to the heat map values and run length sequence, characteristics of the rectangular grid area (e.g., the area of rectangular grid 1112 in FIG. 11) such as the location of one or more of its corners, orientation of the local X and Y axes, and inter-grid point spacing may be provided to other devices.

In the example shown in FIG. 11, heat map values (e.g., forty two RSSI or RTT values) corresponding to the included grid points may be provided to other devices (e.g., to a mobile device). In general, one or more octets may be used to encode each heat map value. The heat map values may be provided as a sequence of values according to some scanning order for the corresponding grid points as previously described. For example, in the case of FIG. 11, a heat map value (e.g., RSSI or RTT value) can be provided first for the grid point at X,Y=2,2, followed based on a scanning order by heat map values for other grid points. In one embodiment, heat map values may be provided as a one dimensional (1-D) sequence—for example as an octet sequence—together with a run length sequence indicating the included and/or excluded grid points. As a result, a first sequence of values (e.g., a first octet string) may provide a run length sequence and indicate the included and/or excluded grid points and a second sequence of values (e.g., a second octet string) may include the heat map information corresponding to the included grid points (or in some embodiments to the included grid points and excluded grid points).

In one embodiment, the sequence of heat map values may be compressed before transmission to other devices. In general, any known compression technique may be used to compress these values. In one embodiment, two-dimensional image based compression techniques, such as JPEG can be used for compression. In one embodiment, where heat map values are only provided for included grid points, the 1-D sequence of heat map values could be mapped into a new rectangular grid area by inverting the scan order mapping shown in FIG. 5A or FIG. 5B (which each show a 2-D to 1-D mapping). Suitable values may be selected for the X and Y lengths of the new rectangle grid area such that the total number of grid points in the new rectangular area equals or only slightly exceeds the number of heat map values in the 1-D sequence. In this embodiment, if the new rectangular 2-D area contains more grid points than that represented by the 1-D sequence, spare grid points may be included in the new 2-D area—e.g., may be included in the final (topmost) row of the new rectangular grid area if the scan order mapping that is inverted corresponds to that exemplified in FIG. 5A or 5B. In that case, a dummy value such as zero may be assigned to each of these spare grid points, thereby enabling values for all grid points in the new 2-D area and thus allowing compression of the heat map values for the 2-D area using image based compression such as JPEG. The 1-D to 2-D mapping in this embodiment may assign heat map values for neighboring grid points along each row in the original grid area to neighboring grid points along each row in the new rectangular grid area although neighboring grid points along each column in the original area may no longer be neighboring in the new area. The ensuing high correlation of heat map values along each row and reduced correlation along each column may still enable some efficiency of two-dimensional image based compression. It should be noted that when a compression technique (e.g., JPEG compression) is used on the heat map data for the new 2-D area, characteristics of the 2-D area (e.g., the X and Y lengths) may also be provided to other devices.

In another embodiment, referred to herein as “run length encoding with compression”, heat map values may be assigned to all grid points in a rectangular grid point area (e.g., to all grid points in the rectangular area 1112 in the example of FIG. 11). The heat map values assigned to the grid point values included in an area of interest (e.g., the forty two included grid points for the heat map area 1114 in the example of FIG. 11) may correspond to values for some signaling characteristic (such as mean RSSI or mean RTT) and may be derived by computation (e.g., at a location server) and/or from measurements (e.g., provided by mobile devices at known locations) as previously described. The heat map values assigned to the grid point values excluded from the area of interest (e.g., the fifty seven excluded grid points for the heat map area 1114 in the example of FIG. 11) may also correspond to values for some signaling characteristic (such as mean RSSI or mean RTT) and may be derived by computation (and/or possibly from measurements provided by mobile devices) as previously described. Alternatively, dummy heat map values may be assigned to excluded grid points (e.g., using a fixed dummy value such as 0, 255, 127 or some value for a nearby included grid point). Heat map values may then be conveyed to other devices (e.g., to a mobile device) for all grid points (included and excluded) and may be compressed prior to transfer using 2-D image based compression such as JPEG. Although heat map values (e.g., dummy values) are now conveyed to other devices for excluded as well as included grid points, the 2-D image based compression may still be efficient and reduce the amount of information that needs to be transferred. For example, if dummy heat map values are assigned to the excluded grid points, the compression may be high because of the perfect correlation between heat map values for adjacent excluded grid points. In this embodiment, a run length sequence defining the included and excluded grid points may also be conveyed along with the compressed heat map values to other devices, to allow the other devices to distinguish the included grid points from the excluded grid points. For example, a recipient device (e.g., a mobile device) may then discard heat map values (e.g., dummy heat map values) that are received for the excluded grid points and may store and later make use only of heat maps values for the included grid points (e.g., in order to help position the recipient device at a later time).

For certain embodiments, two or more of the techniques presented herein for representing heat maps may be combined. For example, reorientation, compression and/or run-length encoding may be combined in any order. In one embodiment, referred to herein as “run length encoding with reorientation”, run length encoding may be combined with reorientation but without compression. In this embodiment, reorientation of a rectangular array of grid points may first be employed to create a reoriented array covering an area resembling a parallelogram as described previously in association with FIGS. 7 and 8. AP vicinity information for a certain signaling characteristic (e.g., mean RSSI or mean RTT) may then be calculated and/or obtained from measurements for each grid point in the reoriented array, after which the reoriented array and its associated grid points may be transformed back into the original rectangular array of grid points, as also described in association with FIGS. 7 and 8. Run length encoding may then be applied to this rectangular array of grid points to define which grid points are to be included and/or excluded. In one embodiment, the included and excluded grid points may be determined from the portion of the reoriented (parallelogram shaped) array that overlays some (e.g., non-rectangular) area of interest prior to transforming the reoriented array back into the original rectangular array of grid points. In this embodiment, a grid point in the rectangular array may be indicated as included if the corresponding grid point in the reoriented array (prior to being shifted back into the rectangular array) lies within or is very close to the area of interest and may be indicated as excluded otherwise. The run length encoding may be indicated using a run length sequence as previously described (e.g., in association with FIG. 11). The run length sequence may be transferred to another device (e.g., a mobile device) along with a description of the rectangular grid point array (e.g., its location, size, orientation and inter-grid point spacing), a description of the reorientation (e.g., an angle) and the AP vicinity information (e.g., encoded values for mean RSSI or mean RTT) for the grid points that are indicated as being included.

In one embodiment, run length encoding may be combined with compression (e.g., JPEG compression) and with or without reorientation. In this embodiment, heat map values may be provided for both included and excluded grid points to allow two-dimensional compression of a complete rectangular array of heat map values. In one embodiment, dummy values (e.g., constant values with high compression potential) may be assigned to the excluded grid points. These dummy values may then be removed at the receiver. When this embodiment does not include reorientation, it may coincide with the “run length encoding with compression” embodiment described previously herein. When this embodiment includes reorientation, it is referred to herein as “run length encoding with compression and reorientation”. In this embodiment, AP vicinity information may be assigned to grid points and a run length sequence may be determined, as described for the “run length encoding with reorientation” embodiment described herein previously. However, instead of just transferring AP vicinity information for grid points indicated as being included to other devices (e.g., a mobile device), AP vicinity information may be transferred for all grid points (included and excluded) by employing 2-D image based compression (e.g., JPEG) to the AP vicinity information (e.g., encoded values for mean RSSI or mean RTT) for the grid points in the original rectangular array of grid points obtained by transforming the reoriented array back into this rectangular array as described for the “run length encoding with reorientation” embodiment. A recipient device (e.g., a mobile device) may ignore (e.g., discard) AP vicinity information received for grid points indicated as being excluded. For example, this AP vicinity information may just comprise dummy values.

It should be noted that the run length sequence indicating the included and/or excluded grid points may start with either the number of excluded grid points or the number of included grid points. The scanning order and the type of the first point in the run length sequence (e.g., included or excluded) may be known by both the transmitter and the receiver (e.g., using some publicly standardized or privately agreed convention). Alternatively, the transmitter may explicitly define these parameters and provide them to the receiver.

### Consecutive Grid Points for Inaccessible Locations

For certain embodiments, an indication of excluded grid points (e.g., by providing alternating runs of included and excluded grid points using a run length sequence) may be used to identify grid points at locations normally inaccessible to a user. Examples of inaccessible locations may include outside of a building above ground level, in an open atrium area above the lowest floor, or inside a building structure (e.g., in an area containing electrical cables, plumbing and/or structural support). In these embodiments, identification of included and excluded points may be used to avoid locating a device (e.g., a mobile device) in such inaccessible locations. Although a device might also infer excluded locations from available map data, there may be cases where map data is not available for positioning or does not align accurately with a heat map area. As a result, an indication of inaccessible locations by excluded points may be useful in a heat map.

In one embodiment, heat map data (e.g., RSSI or RTT) for grid points identified as excluded may or may not be provided to mobile devices. For example, the heat map information for the excluded grid points may be provided in addition to the heat map values corresponding to included grid points (e.g., using values calculated based on building layout). In another embodiment, the heat map data for the excluded grid points may be included in the information provided to mobile devices, but replaced by dummy values that can be compressed more efficiently. In another embodiment, the heat map data for the excluded grid points may be excluded from the heat map data. In this embodiment, only the heat map values for the included grid points may be provided to mobile devices.

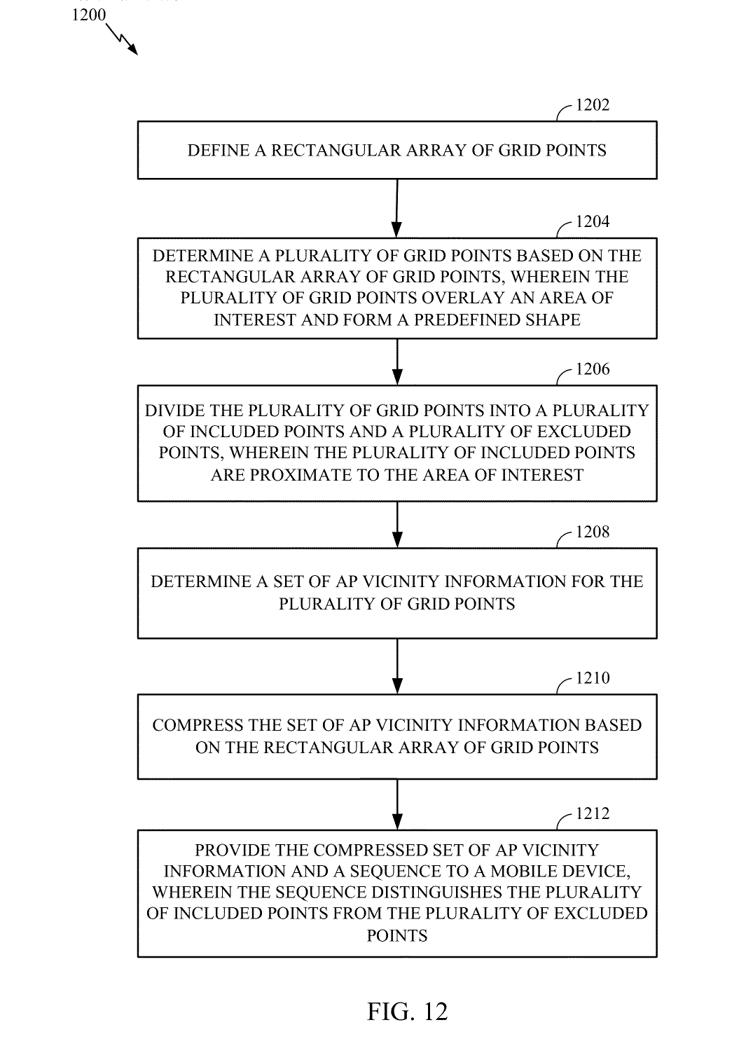

FIG. 12 illustrates example operations 1200 that may be performed by a device such as location server 110 in FIG. 1 to provide AP vicinity information to another device such as mobile device 108 in FIG. 1, in accordance with certain embodiments of the present disclosure. At 1202, a rectangular array of grid points is defined. The rectangular array may be defined as described herein in association with FIG. 2 and FIG. 3. At 1204, a plurality of grid points is determined based on the rectangular array of grid points. The plurality of grid points overlay an area of interest and form a predefined shape. In one embodiment, the plurality of grid points may correspond to the rectangular array of grid points and the predefined shape may be a rectangle. In another embodiment, the plurality of grid points may form a shape resembling a parallelogram and the predefined shape may be the parallelogram. In this embodiment, the plurality of grid points may be determined from the rectangular array of grid points as described herein in association with FIG. 7 and FIG. 8.

In one embodiment, the steps of defining the rectangular array of grid points and determining the plurality of grid points may be merged and be performed as a single step, without departing from the teachings of the present disclosure.

At 1206, the plurality of grid points are divided into a plurality of included points and a plurality of excluded points. The plurality of included points are chosen to be proximate to the area of interest. In one embodiment, one or more of the plurality of included points reside inside the area of interest.

In one embodiment, each of the plurality of excluded points resides outside of the area of interest. In another embodiment, some of the plurality of excluded points reside inside the area of interest, but correspond to inaccessible locations (e.g., part of a building structure or empty space in an atrium above ground level or the lowest floor level), and the like. At 1208, a set of AP vicinity information is determined for the plurality of grid points. The set of AP vicinity information may correspond to encoded values for a particular signaling characteristic (e.g. mean RSSI or mean RTT) for a certain AP and may be calculated and/or obtained from measurements for each of the included grid points and possibly some or all of the excluded grid points as described previously herein. At 1210, the set of AP vicinity information is compressed (e.g., using an image-based compression technique) based on the rectangular array of grid points. The compression may be performed as described previously herein for the “run length encoding with compression” embodiment (e.g. if the predefined shape is a rectangle) or may be performed as described previously herein for the “run length encoding with compression and reorientation” embodiment (e.g. if the predefined shape is a parallelogram). At 1212, the compressed set of AP vicinity information and a sequence are provided to a mobile device (e.g., UE1 108 in FIG. 1). In one embodiment, the sequence distinguishes the plurality of included points from the plurality of excluded points. For example, the sequence may correspond to a “run length sequence” as described previously herein.

The embodiments presented herein (e.g. as described for the example operations 1200 in FIG. 12) allow heat map values to be provided for an area or multiple areas with a much closer fit to a particular geometry of a building and/or an area of interest. This means a smaller fraction of heat map values being provided for locations outside of a building or other area of interest where location support is not needed (e.g., in an open atrium area at floor levels above the lowest). This may result in a reduced amount of data that needs to be sent to a device (e.g. a mobile device) to provide the heat map information. In addition, the additional parameters to define the new area types may be provided to devices efficiently with low overhead.

In one embodiment, known compression techniques (e.g., JPEG compression) may be used in addition to each of the heat map representation techniques as described above. In the case of defining an arbitrary grid map area using a run length sequence, two alternative means of compression using JPEG may be used. In one embodiment, dummy heat map values are assigned to the excluded grid points and values for both included and excluded grid points are compressed as described earlier.

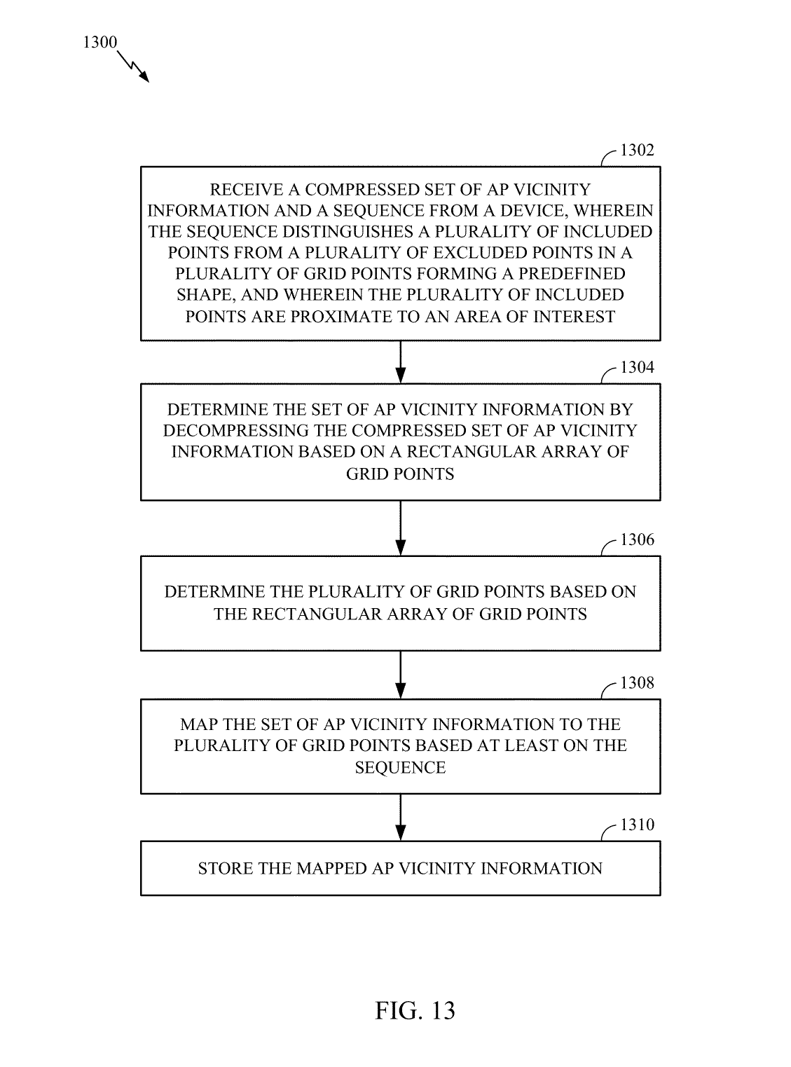

In another embodiment, as described previously herein, heat map values are only provided for the included grid points. These included grid points (which may lie within some non-rectangular area of interest) are first mapped into a rectangular array (e.g., by choosing a suitable length and width for the array and adding dummy values if needed to fill any final row or column in the array). The resulting rectangular array of heap map values is then compressed using JPEG. Although JPEG compression efficiency may be reduced in this embodiment due to lower correlation of nearby heat map values in the rectangular array, since the number of included grid points will be smaller than the total number of grid points in the original grid of points, the amount of data that needs to be provided may be reduced overall if a large number of grid points are excluded. In addition, the method of indicating excluded grid points via consecutive run lengths may be used to indicate inaccessible locations that should not be considered for device location determination. The techniques described above in association with FIGS. 2 to 9 and 11-12 enable a device such as location server 110 in FIG. 1 to efficiently encode vicinity information for an AP, such as AP1 102, AP2 104 or AP3 106 in FIG. 1, and send the encoded AP vicinity information to a mobile device such as UE1 108 in FIG. 1. At a mobile device that receives such encoded AP vicinity information, techniques that are exactly the reverse of those described in association with FIGS. 5A, 5B, 6-9 and 11-12 may be used by the mobile device to recover the original AP vicinity information associated with different grid points over some area of interest. The reverse techniques will be clear to anyone versed in the art and are exemplified herein in association with FIG. 13 which is described next.

FIG. 13 illustrates example operations 1300 that may be performed by a mobile device (e.g., UE1 108 in FIG. 1) to utilize AP heat map information, in accordance with certain embodiments of the present disclosure. At 1302, the mobile device receives a compressed set of AP vicinity information and a sequence from a device (e.g., location server 110 in FIG. 1). The sequence may be a run length sequence and distinguishes a plurality of included points from a plurality of excluded points in a plurality of grid points forming a predefined shape (e.g., rectangle, parallelogram, and the like). The plurality of included points are proximate to an area of interest. In one embodiment, the plurality of included points reside inside the area of interest. At 1304, the mobile device determines the set of AP vicinity information by decompressing the compressed set of AP vicinity information based on a rectangular array of grid points. In an embodiment, the mobile device also receives one or more characteristics of at least one of the rectangular array of grid points and the plurality of grid points from the device that may enable the mobile device to determine the rectangular array of grid points. The mobile device may decompress the AP vicinity information by reversing the procedure used to compress the AP vicinity information—for example, by reversing the procedure described earlier herein for the “run length encoding with compression” embodiment or the “run length encoding with compression and reorientation” embodiment. At 1306, the mobile device determines the plurality of grid points based on the rectangular array of grid points. For example, if one or more characteristics for the rectangular of grid points and the plurality of grid points are received, the mobile device may determine the plurality of grid points by (i) equating the plurality with the rectangular array if the one or more characteristics indicate that reorientation is not performed, or (ii) reorienting the rectangular array of grid points (e.g. as described herein in association with FIG. 7 and FIG. 8) if the one or more characteristics indicate that reorientation is performed. At 1308, the mobile device maps the set of AP vicinity information to the plurality of grid points based at least on the sequence. For example, the mapping may first assign AP vicinity information to grid points in the rectangular array based on the sequence, after which the rectangular array may be reoriented into the plurality of grid points if reorientation is used. At 1310 the mobile device stores the mapped AP vicinity information. For example, the mobile device may use the stored AP vicinity information at a later time to determine or help determine its location as described previously herein.

In one embodiment of example operations 1300, the mobile device determines the rectangular array of grid points based on one or more received characteristics (e.g. number of grid points in a row or column, inter-grid point spacing, location of a corner of the rectangular array, orientation of the rectangular array). The mobile device may then identify grid points in the rectangular array as included or excluded grid points based on the sequence. For example, if the sequence is 3, 2, 5, . . . the mobile device may mark the first three grid points as excluded, the next two grid points as included and the next five grid points as excluded. It should be noted that the mobile device may identify these included and excluded grid points based on a scanning order—e.g. as described herein in association with FIGS. 5A and 5B. The scanning order may be known by both the transmitter (e.g., server) and the receiver (e.g., mobile device). In one embodiment, the scanning order is fixed for all the devices and does not need to be transferred (e.g., can be stored on each device). In another embodiment, the scanning order is device-specific and is transferred when the transmitter and the receiver start communicating. In one embodiment, the device transfers its scanning order on demand

The mobile device may map the decompressed AP vicinity information to the included grid points in the rectangular array of grid points. In one embodiment, the scanning order is used in the mapping process between the AP vicinity information and the included grid points. In one embodiment, the device identifies each grid point in the rectangular array of grid points as an included or an excluded grid point based on the sequence. Then, the device maps the set of AP vicinity information to the included grid points in the rectangular array, and maps the rectangular array of grid points into the plurality of grid points based on one or more received characteristics of the plurality of grid points (e.g. an angle in the case of a plurality of grid points that resemble a parallelogram or the absence of an angle in the case of a plurality of grid points that correspond to the rectangular array of grid points).

In one embodiment, the device first decompresses the received AP vicinity information and maps the decompressed AP vicinity information to the grid points in the rectangular array. In one embodiment, if the decompressed values corresponding to the excluded points are dummy values, the mobile device discards the dummy values and processes the decompressed AP vicinity information corresponding to the included points.

In one embodiment, the mobile device receives one or more characteristics of the predefined shape from the server. For example, the one or more characteristics may comprise a location of a corner of the rectangular array, an orientation of the rectangular array, an inter-grid point spacing, a number of grid points in each row of grid points, a number of grid points in each column of grid points, and/or other characteristics.

In one embodiment, if the predefined shape resembles a parallelogram, the one or more characteristics may further include an angle. The plurality of grid points may correspond to a transformation of the rectangular array of grid points based on the angle. The transformation may correspond to reorientation as described previously herein.

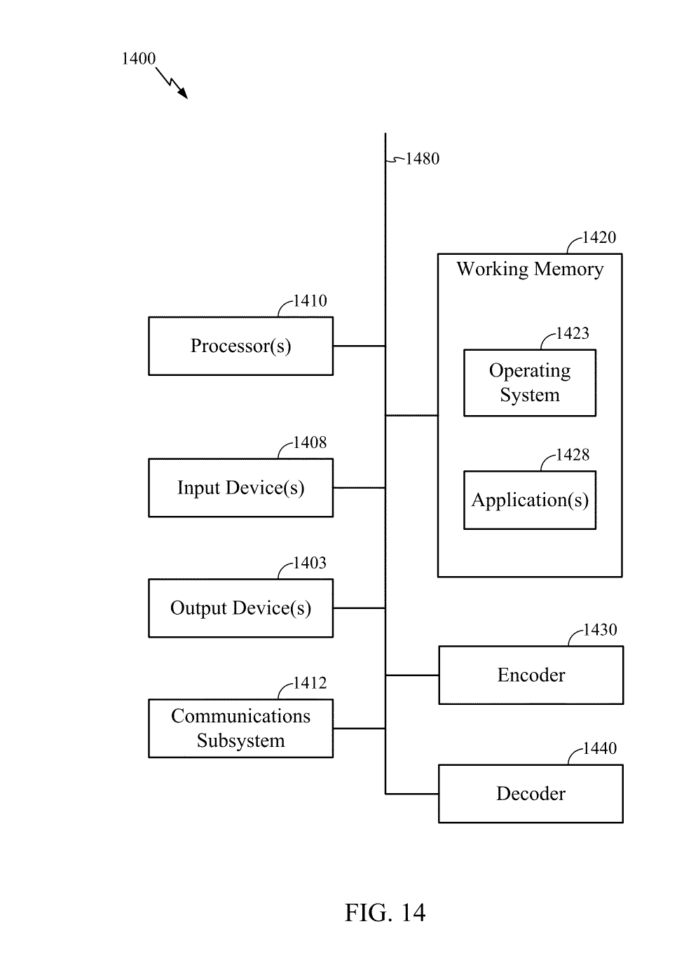

FIG. 14 describes one potential implementation of a device 1400 which may be used to provide or utilize heat map information, according to certain embodiments. In one embodiment, mobile device 108 as described in FIG. 1 may correspond to device 1400 and may be implemented with the specifically described details of process 1000. In another embodiment, location server 110 as described in FIG. 1 may correspond to device 1400 and may be implemented with the specifically described details of process 900. In the embodiment of device 1400 shown in FIG. 14, specialized modules such as encoder 1430 may perform any type of encoding to generate octets representing heat map data (e.g., to support process 900). Device 1400 may also or instead perform decoding of AP vicinity information using a decoder 1440—e.g., if device 1400 is a mobile device and/or to support process 1000. These modules may be implemented to interact with various other modules of device 1400. Memory 1420 may be configured to store data regarding heat maps, and may also store settings and instructions regarding grid orientation, grid size and location, grid spacing, etc.

In the embodiment shown at FIG. 14, the device may be a mobile device or a location server and include processor 1410 configured to execute instructions for performing operations (e.g., to support process 900 and/or process 1000) at a number of components and can be, for example, a general-purpose processor or microprocessor suitable for implementation within a portable electronic device. Processor 1410 may thus implement any or all of the specific steps for operating a compression module as described herein. Processor 1410 is communicatively coupled with a plurality of components within device 1400. To realize this communicative coupling, processor 1410 may communicate with the other illustrated components across a bus 1480. Bus 1480 can be any subsystem adapted to transfer data within device 1400. Bus 1480 can be a plurality of computer buses and include additional circuitry to transfer data.

Memory 1420 may be coupled to processor 1410. In some embodiments, memory 1420 offers both short-term and long-term storage and may in fact be divided into several units. Short term memory may store data which may be discarded after an analysis, or all data may be stored in long term storage depending on user selections. Memory 1420 may be volatile, such as static random access memory (SRAM) and/or dynamic random access memory (DRAM) and/or non-volatile, such as read-only memory (ROM), flash memory, and the like. Furthermore, memory 1420 can include removable storage devices, such as secure digital (SD) cards. Thus, memory 1420 provides storage of computer readable instructions, data structures, program modules, and other data for device 1400. In some embodiments, memory 1420 may be distributed into different hardware modules.

In some embodiments, memory 1420 stores code (e.g., program instructions) for a plurality of applications 1428. Applications 1428 contain particular instructions to be executed by processor 1410. In alternative embodiments, other hardware modules may additionally execute certain applications or parts of applications. Memory 1420 may be used to store computer readable instructions for modules that implement scanning according to certain embodiments, and may also store compact object representations as part of a database.

In some embodiments, memory 1420 includes an operating system 1423. Operating system 1423 may be operable to initiate the execution of the instructions provided by application modules and/or manage other hardware modules as well as interfaces with communications subsystem 1412 which may use a wireless transceiver and an antenna (e.g., if device 1400 is a mobile device) and/or a wireline based transceiver and one or more wireline links (e.g., if device 1400 is a location server). Operating system 1423 may be adapted to perform other operations across the components of device 1400, including threading, resource management, data storage control and other similar functionality.

In some embodiments, device 1400 includes a plurality of other modules (e.g., encoder 1430 and/or decoder 1440). Each of these modules may be a physical module within device 1400 or may be supported as software—e.g., by one or more of applications 1428. As an example, the encoder 1430 may be configured to encode the heat map data as described for process 900. In addition, the decoder 1440 may be configured to decode received heat map data and send them to the processor for further processing—e.g., as described for process 1000.

In certain embodiments, a user may user input devices 1408 (e.g., a keyboard and mouse, a graphical user interface, a microphone) to control creation and/or usage of heat maps—e.g., may select for which APs heat maps are to be created by a location server and for what signaling characteristics. A device 1400 may include a component such as a wireless communications subsystem 1412 which may integrate an antenna and wireless transceiver with any other hardware, firmware, or software necessary for wireless communications. Such a wireless communication subsystem may be configured to receive signals from various devices such as a location server via a wireless network and/or access points such as Wi-Fi access points.

In addition to other hardware modules and applications in memory 1420, a device 1400 may have a display output 1403. Display output 1403 may graphically present information from the device 1400 to a user—e.g., may display for which APs heat maps have been created by a device 1400 that is a server or may display the location of a device 1400 that is a mobile device that is obtained by the device 1400 due to receipt and processing of one or more heat maps. The displayed information may be derived from one or more application modules, one or more hardware modules, a combination thereof, or any other suitable means for resolving graphical content for the user (e.g., by operating system 1423). Display output 1403 can be liquid crystal display (LCD) technology, light emitting polymer display (LPD) technology, or some other display technology. In some embodiments, display output 1403 is a capacitive or resistive touch screen and may be sensitive to haptic and/or tactile contact with a user. In such embodiments, the display output 1403 can comprise a multi-touch-sensitive display.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner.

Specific details are given in the description to provide a thorough understanding of the embodiments. However, embodiments may be practiced without certain specific details. For example, well-known circuits, processes, algorithms, structures, and techniques have been mentioned without unnecessary detail in order to avoid obscuring the embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes which may be depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Additionally, the above elements may merely be a component of a larger system, wherein other rules may take precedence over or otherwise modify the application of various embodiments, and any number of steps may be undertaken before, during, or after the elements of any embodiment are implemented.

Having described several embodiments, it will therefore be clear to a person of ordinary skill that various modifications, alternative constructions, and equivalents may be used without departing from the spirit of the disclosure.

What is claimed is:

1. A method for providing access point (AP) vicinity information, comprising:
defining a rectangular array of grid points;
determining a plurality of grid points based on the rectangular array of grid points, wherein the plurality of grid points overlay an area of interest and form a predefined shape;
dividing the plurality of grid points into a plurality of included points and a plurality of excluded points, wherein the plurality of included points are proximate to the area of interest;
determining a set of AP vicinity information for the plurality of grid points;
compressing the set of AP vicinity information based on the rectangular array of grid points; and
providing the compressed set of AP vicinity information and a sequence to a mobile device, wherein the sequence distinguishes the plurality of included points from the plurality of excluded points.

2. The method of claim 1 wherein the plurality of included points reside inside the area of interest.

3. The method of claim 1 further comprising:
generating the sequence based on a number of consecutive included grid points and a number of consecutive excluded grid points according to a scanning order.

4. The method of claim 3 wherein the scanning order comprises scanning the rectangular array of grid points in one direction starting from a grid point residing on a corner of the rectangular array.

5. The method of claim 1 further comprising:
providing one or more characteristics of at least one of the rectangular array of grid points and the plurality of grid points.

6. The method of claim 5 wherein the rectangular array of grid points comprises rows of grid points and columns of grid points and the one or more characteristics comprise at least one of a location of a corner of the rectangular array, an orientation of the rectangular array, an inter-grid point spacing, a number of grid points in each row of grid points, and number of grid points in each column of grid points.

7. The method of claim 6 wherein the predefined shape corresponds to the rectangular array and the plurality of grid points corresponds to the rectangular array of grid points.

8. The method of claim 6 wherein the predefined shape resembles a parallelogram and wherein the one or more characteristics further comprise an angle and wherein the plurality of grid points is a transformation of the rectangular array of grid points based on the angle.

9. The method of claim 1 wherein the compression uses an image based compression technique.

10. The method of claim 9, wherein the image based compression technique is JPEG.

11. The method of claim 1 wherein one or more of the plurality of excluded points correspond to inaccessible locations.

12. The method of claim 1 wherein determining the set of AP vicinity information for the plurality of grid points comprises assigning dummy values to the excluded points.

13. A method for obtaining access point (AP) vicinity information, comprising:
receiving a compressed set of AP vicinity information and a sequence from a device, wherein the sequence distinguishes a plurality of included points from a plurality of excluded points in a plurality of grid points forming a predefined shape, and wherein the plurality of included points are proximate to an area of interest;
determining the set of AP vicinity information by decompressing the compressed set of AP vicinity information based on a rectangular array of grid points;
determining the plurality of grid points based on the rectangular array of grid points;
mapping the set of AP vicinity information to the plurality of grid points based at least on the sequence; and
storing the mapped AP vicinity information.

14. The method of claim 13 wherein the plurality of included points reside inside the area of interest.

15. The method of claim 13 wherein mapping the set of AP vicinity information to the plurality of grid points comprises:
identifying each grid point in the rectangular array of grid points as an included or excluded grid point based on the sequence;
mapping the set of AP vicinity information to the included grid points in the rectangular array; and
mapping the rectangular array of grid points into the plurality of grid points.

16. The method of claim 13 wherein the sequence comprises a number of consecutive included grid points and a number of consecutive excluded grid points according to a scanning order.

17. The method of claim 16 wherein the scanning order comprises scanning the rectangular array of grid points in one direction starting from a grid point residing on a corner of the rectangular array.

18. The method of claim 13 further comprising:
receiving one or more characteristics of at least one of the rectangular array of grid points and the plurality of grid points from the device.

19. The method of claim 18 wherein the rectangular array of grid points comprise rows of grid points and columns of grid points and the one or more characteristics comprise at least one of a location of a corner of the rectangular array, an orientation of the rectangular array, an inter-grid point spacing, a number of grid points in each row of grid points, and number of grid points in each column of grid points.

20. The method of claim 19 wherein the predefined shape corresponds to the rectangular array and the plurality of grid points corresponds to the rectangular array of grid points.

21. The method of claim 19 wherein the predefined shape resembles a parallelogram and wherein the one or more characteristics further comprise an angle and wherein the plurality of grid points corresponds to a transformation of the rectangular array of grid points based on the angle.

22. The method of claim 13 wherein the decompression uses an image based decompression technique.

23. The method of claim 22, wherein the image based decompression technique is JPEG.

24. The method of claim 13 wherein one or more of the plurality of excluded points correspond to inaccessible locations.

25. The method of claim 13 wherein AP vicinity information for the excluded grid points comprises dummy values.

26. An apparatus for providing access point (AP) vicinity information, comprising:
at least one processor configured to:
define a rectangular array of grid points,
determine a plurality of grid points based on the rectangular array of grid points, wherein the plurality of grid points overlay an area of interest and form a predefined shape,
divide the plurality of grid points into a plurality of included points and a plurality of excluded points, wherein the plurality of included points are proximate to the area of interest,
determine a set of AP vicinity information for the plurality of grid points,
compress the set of AP vicinity information based on the rectangular array of grid points, and
provide the compressed set of AP vicinity information and a sequence to a mobile device, wherein the sequence distinguishes the plurality of included points from the plurality of excluded points; and
a memory coupled to the at least one processor.

27. The apparatus of claim 26 wherein the plurality of included points reside inside the area of interest.

28. The apparatus of claim 26 wherein the at least one processor is further configured to:
generate the sequence based on a number of consecutive included grid points and a number of consecutive excluded grid points according to a scanning order.

29. An apparatus for obtaining access point (AP) vicinity information, comprising:
at least one processor configured to:
receive a compressed set of AP vicinity information and a sequence from a device, wherein the sequence distinguishes a plurality of included points from a plurality of excluded points in a plurality of grid points forming a predefined shape, and wherein the plurality of included points are proximate to an area of interest,
determine the set of AP vicinity information by decompressing the compressed set of AP vicinity information based on a rectangular array of grid points,
determine the plurality of grid points based on the rectangular array of grid points,
map the set of AP vicinity information to the plurality of grid points based at least on the sequence, and
store the mapped AP vicinity information; and
a memory coupled to the at least one processor.

30. The apparatus of claim 29 wherein the at least one processor is further configured to:
identify each grid point in the rectangular array of grid points as an included or excluded grid point based on the sequence;
map the set of AP vicinity information to the included grid points in the rectangular array; and
map the rectangular array of grid points into the plurality of grid points.

31. An apparatus for providing access point (AP) vicinity information, comprising:
means for defining a rectangular array of grid points;
means for determining a plurality of grid points based on the rectangular array of grid points, wherein the plurality of grid points overlay an area of interest and form a predefined shape;
means for dividing the plurality of grid points into a plurality of included points and a plurality of excluded points, wherein the plurality of included points are proximate to the area of interest;
means for determining a set of AP vicinity information for the plurality of grid points;
means for compressing the set of AP vicinity information based on the rectangular array of grid points; and
means for providing the compressed set of AP vicinity information and a sequence to a mobile device, wherein the sequence distinguishes the plurality of included points from the plurality of excluded points.

32. The apparatus of claim 31 wherein the plurality of included points reside inside the area of interest.

33. The apparatus of claim 31 further comprising:
means for generating the sequence based on a number of consecutive included grid points and a number of consecutive excluded grid points according to a scanning order.

34. The apparatus of claim 33 wherein the scanning order comprises scanning the rectangular array of grid points in one direction starting from a grid point residing on a corner of the rectangular array.

35. The apparatus of claim 31 further comprising:
means for providing one or more characteristics of at least one of the rectangular array of grid points and the plurality of grid points.

36. The apparatus of claim 35 wherein the rectangular array of grid points comprises rows of grid points and columns of grid points and the one or more characteristics comprise at least one of a location of a corner of the rectangular array, an orientation of the rectangular array, an inter-grid point spacing, a number of grid points in each row of grid points, and number of grid points in each column of grid points.

37. An apparatus for obtaining access point (AP) vicinity information, comprising:
means for receiving a compressed set of AP vicinity information and a sequence from a device, wherein the sequence distinguishes a plurality of included points from a plurality of excluded points in a plurality of grid points forming a predefined shape, and wherein the plurality of included points are proximate to an area of interest;
means for determining the set of AP vicinity information by decompressing the compressed set of AP vicinity information based on a rectangular array of grid points;
means for determining the plurality of grid points based on the rectangular array of grid points;
means for mapping the set of AP vicinity information to the plurality of grid points based at least on the sequence; and
means for storing the mapped AP vicinity information.

38. The apparatus of claim 37 wherein the plurality of included points reside inside the area of interest.

39. The apparatus of claim 37 further comprising:
means for identifying each grid point in the rectangular array of grid points as an included or excluded grid point based on the sequence;
means for mapping the set of AP vicinity information to the included grid points in the rectangular array; and
means for mapping the rectangular array of grid points into the plurality of grid points.

40. The apparatus of claim 37 wherein the sequence comprises a number of consecutive included grid points and a number of consecutive excluded grid points according to a scanning order.
